(19) United States
(12) Patent Application Publication
(10) Pub. No.: US 2025/0224565 A1
(43) Pub. Date: Jul. 10, 2025

(54) TEMPLATED PHOTONIC STRUCTURES AND RESONATORS AND METHODS OF FABRICATING THE SAME

(71) Applicant: The Regents of The University of Michigan, Ann Arbor, MI (US)

(72) Inventors: Wei-Kuan LIN, Ann Arbor, MI (US); Lingjie Jay GUO, Ann Arbor, MI (US)

(73) Assignee: The Regents of The University of Michigan, Ann Arbor, MI (US)

(21) Appl. No.: 19/016,383

(22) Filed: Jan. 10, 2025

Related U.S. Application Data
(60) Provisional application No. 63/619,637, filed on Jan. 10, 2024.

(51) Int. Cl. G02B 6/293; B82Y 20/00; B82Y 30/00; G02B 6/136

(52) U.S. Cl. CPC G02B 6/29338; G02B 6/136; B82Y 20/00; B82Y 30/00

(57) ABSTRACT

Methods of making optic structures (e.g., microring resonator, meta-elements) include imprinting a first surface of a moldable polymer having at least one inverse micro/nano-feature into a second surface of a first polymeric cladding layer disposed on a second substrate to form at least one trench micro/nano-feature contrapositive to the at least one inverse micro/nano-feature. A liquid polymeric precursor is applied into the at least one trench micro/nano-feature where it is solidified to form a solid polymer. A difference between a first refractive index of the first cladding layer and a second refractive index of the solid polymer is ≥about 0.05. The solid is heated for thermal reflow to define a meniscus followed by applying a second polymeric cladding layer thereon. Organic cladded (e.g., microring resonator) optic structures are also provided, which may have a quality (Q)-factor of ≥about 5×10⁵ around 770 nm wavelength).

### CROSS-REFERENCE TO RELATED APPLICATIONS

This application claims the benefit of U.S. Provisional Application No. 63/619,637, filed on Jan. 10, 2024. The entire disclosure of the above application is incorporated herein by reference.

### FIELD

The present disclosure relates to methods of making a cladded organic optic structure, such as an organic microring resonator optic structure and such optic structures made therefrom.

### BACKGROUND

This section provides background information related to the present disclosure which is not necessarily prior art.

High-quality factor optical microring resonators (MRRs) have been widely used in various applications, ranging from biomedicine to quantum information, including biosensing, acoustic detection, optical filters, temperature sensing, integrated photonics, and quantum information processing, among others. A microring resonator typically includes a circular microring and a bus waveguide with a few hundred nanometers gap disposed therebetween. The microring resonant bandwidth greatly depends on the quality of fabrication, such as sidewall smoothness and waveguide width uniformity, which strongly influence the device's performance. To obtain a narrow bandwidth, high-quality factor (Q-factor) microring resonator, the fabrication of microring resonators requires high-resolution and high-fidelity pattern-defining technologies.

Thus, the versatile functionalities of microring resonators derive from the intrinsic properties of the materials that make up the microring, and the quality-factor (Q-factor) of the resonator. The material properties determine the response of the microring resonator to environmental changes or external excitation, as well as the optical characteristics of the device. A high Q-factor of the microring resonator is an important aspects of function, as a stronger field inside the cavity can enhance the light-matter interaction, resulting in an amplified optical response. The Q-factor is also directly related to the sensitivity of optical sensor devices. Therefore, realizing microring resonators using a wide range of materials to achieve high Q-factors is highly desired.

Many high Q-factor microrings have been made from inorganic materials by using standard semiconductor microfabrication technologies. For example, Si₃N₄ and LiNBO₃ microrings can be fabricated by electron-beam (E-beam) lithography and/or Deep UV (DUV) lithography followed by dry etching to achieve a Q-factor of greater than 10⁸. Chalcogenide glass and silicon (Si) microrings can also use similar strategies to achieve a Q-factor in the range of approximately 10⁵ to 10⁶.

On the other hand, polymeric materials possess various properties that typical inorganic materials do not have, such as high photoelasticity and low modulus, and can be utilized for sensing applications. However, standard fabrication methods generally cannot apply to polymer microring resonators. A high Q-factor microring resonator requires reducing the light propagation loss to a minimum, and this has presented challenges to the fabrication from polymers, not only because a nanoscale (e.g., approximately 100-nm in the coupling region of the device) feature size is required but also surface roughness of the waveguide must be tightly controlled. The prevalent method for microring fabrication is E-beam lithography, which is a costly and low throughput process due to direct writing with numerous restrictions, such as the selection of materials and substrates. Two-photon photopolymerization is also proposed, but the Q-factor is limited. In the past two decades, nanoimprinting lithography (NIL) has been used and successfully fabricated polymer microring resonators with Q-factor exceeding 5×10⁵. The molding process of NIL offers the advantage of the reduced fabrication time once a mold is fabricated, and high pattern fidelity of NIL ensures faithful and repeatable waveguide pattern definition. However, NIL suffers from defect issues and requires specific tools for uniform pressure and temperature control to pattern the polymer microrings. NIL always leaves a residual layer around the microring waveguide that causes radiation loss. Moreover, a high-class cleanroom environment is needed to avoid dust particles in critical regions of the device to achieve high Q-factor and low defects microring resonators. Thus, methods of forming high fidelity optical devices, like high-quality-factor microring resonators, from polymeric materials are highly desirable without requiring extensive and expensive equipment and clean rooms.

### SUMMARY

This section provides a general summary of the disclosure, and is not a comprehensive disclosure of its full scope or all of its features.

In certain aspects the present disclosure relates to a method of making a templated optical structure, such as a cladded organic optic structure. The method comprises patterning a first surface of a moldable polymer disposed on a first substrate by contacting a rigid inverse mold having at least one trench microfeature with the first surface of the moldable polymer to define at least one inverse trench microfeature in the first surface. The method also comprises imprinting the first surface of the moldable polymer having the at least one inverse trench microfeature into a second surface of a first polymeric cladding layer disposed on a second substrate to replicate the at least one trench microfeature contrapositive to the at least one inverse microfeature in the second surface, wherein the first polymeric cladding layer has a first refractive index. A liquid polymeric precursor is applied into the at least one trench microfeature on the second surface of the first polymeric cladding layer. The method includes solidifying the liquid polymeric precursor to form a solid polymer having a second refractive index, wherein a difference between the first refractive index and the second refractive index is greater than or equal to about 0.05. Next, the method comprises heating the solid polymer to facilitate retraction from regions of the second surface external to the at least one trench microfeature and annealing for thermal reflow of the solid polymer in the at least one trench microfeature. Then, in certain variations, the method comprises applying a second polymeric cladding layer over the solid polymer in the at least one trench microfeature in the second surface of the first polymeric cladding layer. The solid polymer disposed in the at least one trench microfeature defines an optic feature embedded in the first polymeric cladding layer and optionally in the second polymeric cladding layer.

In one aspect, the liquid polymeric precursor comprises of one or more polymer precursors dissolved in a solution.

In one aspect, the applying a liquid polymeric precursor comprises spin casting the liquid polymeric precursor into the at least one trench on the surface of the first polymeric layer.

In one further aspect, the spin casting further comprises at least two spin casting steps of the liquid polymeric precursor to form at least two layers in the at least one trench on the surface of the first polymeric layer.

In another aspect, the applying a liquid polymeric precursor into the at least one trench comprises a printing process selected from the group consisting of: ink-jet printing, aerosol jet printing, electrohydrodynamic printing, photoacoustic printing, and combinations thereof.

In another aspect, the applying a liquid polymeric precursor comprises inkjet printing the liquid polymeric precursor into the at least one trench on the surface of the first polymeric layer.

In one aspect, the moldable polymer comprises polyurethaneacrylate (PUA).

In one aspect, the first polymeric cladding and the second polymeric cladding respectively comprise polyurethaneacrylate (PUA).

In one aspect, the regions of the second surface external to the at least one trench microfeature are substantially free of any solid polymer.

In one aspect, the moldable polymer is:
(i) a liquid comprising an ultraviolet radiation (UV)-curable polymer precursor and the patterning of the first surface of the moldable polymer further comprises applying ultraviolet (UV) radiation to cure the liquid to form a solid moldable polymer during the contacting with the rigid inverse mold;
(ii) a liquid comprising a thermosetting polymer precursor and the patterning of the first surface of the moldable polymer further comprises applying thermal energy to cure the liquid to form a solid moldable polymer during the contacting with the rigid inverse mold; or
(iii) a thermoplastic polymer and the patterning of the first surface of the moldable polymer further comprises applying heat and pressure to form a solid moldable polymer during the contacting with the rigid inverse mold.

In one aspect, the first polymeric cladding layer is formed from:
(i) a liquid comprising an ultraviolet radiation (UV)-curable polymer precursor and the imprinting further comprises applying ultraviolet (UV) radiation to cure the liquid to form the solid first polymeric cladding layer having the at least one trench microfeature in the second surface;
(ii) a liquid comprising a thermoset polymer precursor and the imprinting further comprises applying pressure and heat to cure the liquid to form the solid first polymeric cladding layer having the at least one trench microfeature in the second surface;
(iii) a liquid comprising a thermoplastic polymer and the imprinting further comprises applying pressure and heat to form the solid first polymeric cladding layer having the at least one trench microfeature in the second surface; or
(iv) a liquid comprising cross-linked molecules that after solidification forms an aerogel material having a porous network of the cross-linked molecules.

In one aspect, the optional second polymeric cladding layer is formed from:
(i) a liquid comprising an ultraviolet radiation (UV)-curable polymer precursor and the applying the second polymeric cladding layer over the solid polymer in the at least one trench microfeature in the second surface of the first polymeric cladding layer further comprises applying ultraviolet (UV) radiation to cure the liquid to form a solid second polymeric cladding layer;
(ii) a liquid comprising a thermoset polymer precursor and the applying the second polymeric cladding layer over the solid polymer in the at least one trench microfeature in the second surface of the first polymeric cladding layer further comprises applying heat to cure the liquid to form a solid second polymeric cladding layer; or
(iii) a liquid comprising a thermoplastic polymer and the applying the second polymeric cladding layer over the solid polymer in the at least one trench microfeature in the second surface of the first polymeric cladding layer further comprises applying heat or solvent evaporation to form a solid second polymeric cladding layer.
   wherein the solid polymer is selected from the group consisting of: polystyrene (PS), polycarbonate (PC), polymethylmethacrylate (PMMA), epoxy-based resin, silsesquioxane resin, electrooptic polymers, thermooptic polymers, photothermal polymers, photoelastic polymers, and combinations thereof.

In one aspect, the solid polymer comprises a polymer further comprising a dye or quantum dot.

In one aspect, the solid polymer is a composite comprising a nanoparticle distributed in a polymer matrix. The nanoparticle may be an inorganic nanoparticle.

In one aspect, the solid polymer comprises polystyrene (PS).

In one aspect, the second substrate comprises a flexible polymer.

In one aspect, after the heating, the second surface of the first cladding layer is free of any residual solid polymer having the second refractive index without any additional removal processes.

In certain further aspects the present disclosure relates to a method of making an organic microring resonator optic structure. The method comprises patterning a first surface of a moldable polymer disposed on a first substrate by contacting a rigid inverse mold having at least one trench microfeature with the first surface of the moldable polymer to define at least one inverse trench microfeature in the first surface. The method further comprises imprinting the first surface of the moldable polymer having the at least one inverse trench microfeature into a second surface of a first polymeric cladding layer disposed on a second substrate to replicate the at least one trench microfeature contrapositive to the at least one inverse trench microfeature in the second surface. The first polymeric cladding layer has a first refractive index. The method also comprises applying a liquid polymeric precursor into the at least one trench microfeature on the second surface of the first polymeric cladding layer and solidifying the liquid polymeric precursor to form a solid polymer having a second refractive index. A difference between the first refractive index and the second refractive index is greater than or equal to about 0.05. The method also further comprises heating the solid polymer to facilitate retraction from regions of the second surface external to the at least one trench microfeature and annealing for thermal reflow of the solid polymer in the at least one trench microfeature. The solid polymer disposed in the at least one trench microfeature defines a waveguide of the microring resonator embedded in the first polymeric cladding layer and the second polymeric cladding layer. The microring resonator has a quality (Q)-Factor of greater than or equal to about 1×10⁵ at a wavelength of about 770 nm.

In one aspect, the regions of the second surface external to the at least one trench microfeature are substantially free of any solid polymer.

In one aspect, the moldable polymer comprises polyurethaneacrylate (PUA).

In one aspect, the first polymeric cladding and the second polymeric cladding respectively comprise polyurethaneacrylate (PUA).

In one aspect, the solid polymer is selected from the group consisting of: polystyrene (PS), polycarbonate (PC), epoxy-based resin, polymethylmethacrylate (PMMA), silsesquioxane resin, electrooptic polymers, thermooptic polymers, photothermal polymers, photoelastic polymers, and combinations thereof.

In one aspect, the solid polymer comprises a polymer further comprising a dye or a quantum dot.

In one aspect, the solid polymer is a composite comprising a nanoparticle distributed in a polymer matrix.

In one aspect, the second substrate comprises a flexible polymer.

In one aspect, the first polymeric cladding and the second polymeric cladding respectively comprise polyurethaneacrylate (PUA) and the solid polymer comprises polystyrene (PS).

In one aspect, after the heating, the second surface of the first cladding layer is free of any residual solid polymer having the second refractive index without any additional removal processes.

In certain other aspects, the present disclosure relates to an organic microring resonator optic structure that comprises a first polymeric cladding layer disposed on a substrate having at least one trench microfeature, where the first polymeric cladding layer has a first refractive index. The structure further comprises a solid polymer having a second refractive index disposed in the at least one trench microfeature and defining a meniscus, wherein a difference between the first refractive index and the second refractive index is greater than or equal to about 0.05. The regions external to the at least one trench microfeature of the first polymeric cladding layer are substantially free of the solid polymer. The structure also comprises a second polymeric cladding layer disposed over the second surface and the solid polymer in the at least one trench microfeature, where the solid polymer is disposed in the at least one trench microfeature and defines a waveguide of the microring resonator embedded in the first polymeric cladding layer and the second polymeric cladding layer. The microring resonator may have a quality (Q)-Factor of greater than or equal to about 1×10⁵ at a wavelength of about 770 nm quality.

In one aspect, the solid polymer is selected from the group consisting of: polystyrene (PS), polycarbonate (PC), epoxy-based resin, polymethylmethacrylate (PMMA), silsesquioxane resin, electrooptic polymers, thermooptic polymers, photothermal polymers, photoelastic polymers, and combinations thereof.

In one aspect, the solid polymer comprises a polymer further comprising a dye or a quantum dot.

In one aspect, the solid polymer is a composite comprising a nanoparticle distributed in a polymer matrix.

In one aspect, the substrate comprises a flexible polymer.

In one aspect, the first polymeric cladding and the second polymeric cladding respectively comprise polyurethaneacrylate (PUA) and the solid polymer comprises polystyrene (PS).

In one aspect, the surface regions external to the at least one trench microfeature of the first cladding layer are free of any residual solid polymer having the second refractive index.

In certain further aspects, the present disclosure relates to a method of making a templated optical structure. The method comprises patterning a first surface of a moldable polymer disposed on a first substrate by contacting a rigid inverse mold having at least one trench microfeature with the first surface of the moldable polymer to define at least one inverse trench microfeature in the first surface. The method also comprises imprinting the first surface of the moldable polymer having the at least one inverse trench microfeature into a second surface of a first polymeric cladding layer disposed on a second substrate to replicate the at least one trench microfeature contrapositive to the at least one inverse trench microfeature in the second surface. The first polymeric cladding layer has a first refractive index. The method also comprises applying a liquid polymeric precursor into the at least one trench microfeature on the second surface of the first polymeric cladding layer and solidifying the liquid polymeric precursor to form a solid polymer having a second refractive index. A difference between the first refractive index and the second refractive index is greater than or equal to about 0.05.

In certain aspects, the method further comprises heating the solid polymer to facilitate retraction from regions of the second surface external to the at least one trench microfeature and annealing for thermal reflow of the solid polymer in the at least one trench microfeature.

In certain aspects, the method further comprises applying a second polymeric cladding layer over the solid polymer in the at least one trench microfeature in the second surface of the first polymeric cladding layer. The solid polymer is disposed in the at least one trench microfeature defines an optic feature embedded in the first polymeric cladding layer and the second polymeric cladding layer.

In certain aspects, the method further comprises selectively removing the first polymeric cladding layer while leaving the solid polymer having the second refractive index intact.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows an overhead view of an example of a cladded organic optic structure in the form of an optical microring resonator.

FIG. 2 shows a sectional side view of the optical microring resonator in FIG. 1.

FIGS. 3A-3C show comparative fabrication processes of microring resonators, including through one variation of an inventive method involving modified Damascene Nano-imprint Lithography (DsNIL). In FIG. 3A, a process flow chart shows a rigid inverse mold made of silicon (Si) having at least one trench microfeature. In FIG. 3B, a process flow chart of a traditional thermal embossing nanoimprinting method is shown for comparison. FIG. 3C shows a process flow chart according to certain methods of the present disclosure involving modified Damascene Nano-imprint Lithography (DsNIL). Corresponding reference numerals indicate corresponding parts throughout the several views of the drawings.

FIGS. 4A-4C show microring resonators formed according to certain aspects of the present disclosure and Q-factor measurements. FIG. 4A shows a Scanning Electron Microscopy (SEM) image of a microring resonator array with approximately a 200 micrometers (μm) diameter. Each bus waveguide contains 4 rings with slightly different diameters. The distances between the bus waveguides and the rings are slightly different. FIG. 4B shows the coarse spectrum of the microring resonators. Each of the boxes indicates the FSR of the respective microring resonators. FIG. 4C shows the fine scan of the microring resonator with Lorentzian fitting. The fitted linewidth is 1.6 μm, corresponding to a Q Factor of approximately 480,000.

FIGS. 5A-5C are SEM images. FIG. 5A includes FIGS. 5A(i)-5A(iii) that show sidewall roughness of different surfaces. More specifically, FIG. 5A(i) shows the sidewall of a rigid silicon (Si) mold, FIG. 5A(ii) shows a sidewall of a polyurethaneacrylate (PUA) mold, and FIG. 5A(iii) shows a sidewall of an imprinted trench in a layer of PUA. FIG. 5B includes FIGS. 5B(i)-5B(iii) that show residual layers. More specifically, FIG. 5B(i) shows the trench in the PUA layer filled with core material, FIG. 5B(ii) shows there is no residual layer on the PUA near the trench filled with core material, and FIG. 5B(iii) shows a magnified view of the coupling area of the bus waveguide to microring. FIG. 5C shows a cross-sectional profile of the cladded structure formed, including a lower cladding, a core material disposed in the trench of the lower cladding, and an upper cladding disposed thereon.

FIGS. 6A-6C show simulation results of mode profiles and radiation loss of microring resonators fabricated by the methods according to certain variations of the present disclosure (DsNIL methods) compared to that of conventional thermal embossing nano-imprint lithography (NIL). FIG. 6A includes FIGS. 6A(i)-6A(ii) that show the refractive index cross-sectional profiles, where FIG. 6A(i) shows a core region formed by conventional thermal embossing NIL versus FIG. 6A(ii) that shows a core region disposed in a trench formed via one variation of a DsNIL method according to the present disclosure. FIG. 6B(i) shows the electric field profiles of the fundamental traverse electric (TE) mode with 200 micrometers (μm) bending diameter for the conventional structure in FIG. 6A(i), while FIG. 6B(ii) shows the electric field profiles of the fundamental traverse electric (TE) mode with 200 micrometers (μm) bending diameter for the inventive structure in FIG. 6A(ii). FIG. 6C includes FIGS. 6C(i)-6C(ii) showing radiation loss of both TE and transverse magnetic (TM) modes of the microring resonators with 200 micrometers (μm) bending diameters. FIG. 6C(i) indicates microring resonators fabricated by the conventional thermal embossing method comparing radiation loss versus residual layer thickness (nm) and FIG. 6C(ii) shows microring resonators fabricated by the inventive DsNIL method for radiation loss versus filling ratio.

FIGS. 7A-7D show advantages of microring resonators fabricated by the methods according to certain variations of the present disclosure (DsNIL methods) besides high Q and being residual-layer free. FIG. 7A includes FIGS. 7A(i)-7A(ii). FIG. 7A(ii) shows that structures made via the inventive DsNIL processes suffer from fewer defects as compared to structures made with conventional hard mold thermal embossing NIL, as shown in FIG. 7A(i). FIG. 7B includes FIGS. 7B(i)-7B(ii) that are SEM images of microring resonators fabricated by certain variations of the inventive DsNIL methods filled with different polymers. FIG. 7B(i) shows a structure with a core region formed of SU-8 polymer, while FIG. 7B(ii) shows a core region formed with polycarbonate (PC). FIG. 7C shows that a filling ratio of the trench region when using the inventive DsNIL methods is tunable. FIG. 7D includes FIGS. 7D(i)-7D(ii) where inventive DsNIL methods are performed on a flexible PET substrate as shown in FIG. 7D(i) with high precision and further showing residual layer free in FIG. 7D(ii).

FIGS. 8A-8D show a meniscus profile of a filled trench can be tuned based on a concentration of a polymer. In FIGS. 8A-8D, the meniscus profile varies with the concentration of the polystyrene ((PS) ranging from about 5% (FIG. 8A), about 7.5% (FIG. 8B), about 10% (FIG. 8C), up to about 15% (FIG. 8D)). The filling height or ratio (“f”) increases with the polymer concentration, for example, ranging from a filling height of 43% (FIG. 8A), 53% (FIG. 8B), 80% (FIG. 8C), up to about 90% (FIG. 8D).

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges. Further, each specified value or endpoint can define a maximum value or upper bound (for example, specifying greater than 0 to the maximum value) or a minimum value or lower bound (for example, specifying the minimum value to 100).

Example embodiments will now be described more fully with reference to the accompanying drawings.

The present application contemplates new methods of forming organic optic structures, especially cladded organic optic structures. In various aspects, the methods can be considered to be modified “damascene soft nanoimprinting lithography” that will be described further herein that can create high-fidelity waveguides. In certain aspects, the methods include simply backfilling an imprinted cladding pattern with a high refractive index material, such as a high refractive index polymer, that defines a core region with cladding adjacent to it. Such methods readily form high Q-factor microring resonators without the use of any expensive instruments and can be conducted in a normal lab environment (e.g., about 5×10⁵ around 770 nm wavelength). The high Q-factors of the cladded optic structures formed from such methods can be attributed at least in part to the residual layer-free feature, reduced interface roughness between the core and cladding materials and controllable meniscus cross-section profile of the filled polymer core. Furthermore, such methods are compatible with different polymers, yield low fabrication defects, enable new functionalities, and allow flexible substrates. These benefits can broaden the applicability of the fabricated microring resonator and other cladded optic structures.

The methods include damascene soft nanoimprinting lithography (DsNIL) methods, for example, using only polymers and no inorganic materials, for polymer microring fabrication. The methods provided by the present disclosure address the high-cost issue of E-beam lithography, and inherit the high-resolution and high-speed characteristics of nanoimprint, but advantageously are residual layer-free. The typical defects arising from a traditional nanoimprinting approach are substantially diminished. The methods of the present application are thus low cost, with high fabrication speed, and low defects. In certain variations, the microring resonators formed by the present methods demonstrate a Q-factor of about 500,000 (5×10⁵), close to the record Q-factor for polymeric microring resonators. The methods provided by various aspects of the present disclosure are easy to implement and can be carried out under typical operating conditions without the use of dedicated tools or a cleanroom environment. Moreover, the methods are high throughput, such that wafer-scale microring resonator array based photonic integrated circuits can be fabricated within minutes.

In contrast to most of the existing approaches, the methods of the present disclosure pattern a waveguide cladding layer through a soft nanoimprint lithography technique (e.g., an ultraviolet (UV) curable soft NIL) that avoids the necessity of high pressure and high temperature that introduces opportunities for defects to arise. After patterning the cladding trenches, high refractive index polymers may be applied by a simple process, such as spin-coating, followed by thermal reflow that occurs by annealing, to fill the trench feature and form the waveguide core layer. This method naturally eliminates the residual layer near the waveguide as commonly seen in conventional NIL methods. Furthermore, the cross-section of the waveguide can be controlled by the shape of meniscus of the filled waveguide core polymer. Importantly, a high Q-factor microring resonator can be fabricated in a regular lab environment without the requirement of delicate tools or clean room (e.g., low dust or dust free conditions). Different substrates hard or soft, such as silicon (Si) and polyethylene terephthalate (PET) plastic may be used with certain aspects of the fabrication methods.

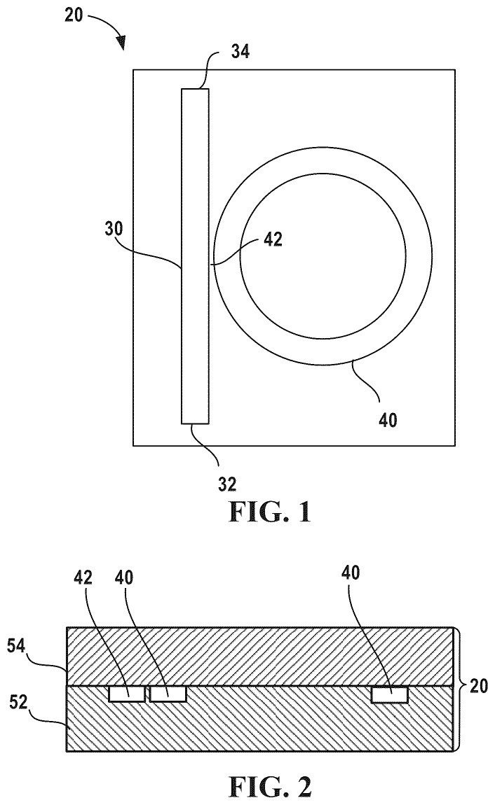

As shown in FIGS. 1 and 2, an example of a cladded organic optic structure, namely a typical optical microring resonator 20 design is shown in overhead and cross-sectional views. At least one linear bus waveguide 30 may have an input 32 and an output 34 through which a beam of light can pass. The optical microring resonator 20 also has a closed loop or circular ring 40. There is a gap 42 disposed between the linear bus waveguide 30 and a portion of the circular ring 40, which may be a few hundred nanometers thick. In this manner, when a beam of light passes through the linear bus waveguide 30, a portion of the light is coupled into the circular ring 40 across the gap 42, where the circular ring 40 serves as a resonator. The linear bus waveguide 30 and the circular ring 40 resonator may define an optically active core 50 of the optical microring resonator 20 and may comprise a high refractive index material that contrasts with a lower refractive index adjacent material (e.g., cladding). Thus, as best seen in FIG. 2, the optically active core 50 may be at least partially defined in a lower cladding layer 52, so that the lower cladding layer 52 is adjacent to the core 50 in certain regions. Further, an upper cladding layer 54 may be disposed over the optically active core 50 and the lower cladding layer 52.

The upper cladding layer 52 and the lower cladding layer 54 may be formed of a low refractive index material, referring to a real part of the refractive index (n), which may be the same composition or different compositions. As noted above, the core 50 may be formed of a high refractive index material, again referring to the real part of refractive index (n). The at least one linear waveguide 30 and the circular ring 40 resonator may be formed of the same or different compositions. In general, a sufficient difference between the high refractive index and low refractive index materials can provide the desired optical effect, for example a difference between the refractive index (n_{H}) of the high refractive index material and refractive index (n_{L}) of the low refractive index material (n_{H}−n_{L}=Δn) is greater than or equal to about 0.05, optionally greater than or equal to about 0.09, optionally greater than or equal to about 0.1, optionally greater than or equal to about 0.25, optionally greater than or equal to about 0.5, optionally greater than or equal to about 0.75, optionally greater than or equal to about 1, optionally greater than or equal to about 1.25, optionally greater than or equal to about 1.5, and optionally greater than or equal to about 1.75

The materials selected for the high refractive index core 50, for example, defining the at least one linear waveguide 30 and the circular ring 40 resonator, and the materials selected from the low refractive index layer for the upper and lower cladding layers provide a high refractive index contrast. By way of non-limiting example, at least one high refractive index material of the core 50 may have a real part of a refractive index (n) of greater than or equal to about 1.5, optionally greater than or equal to about 2, and optionally greater than or equal to about 2.5. Similarly, the low refractive index material of the upper and/or lower cladding layers 54, 52 may have a real part of the refractive index (n) of less than or equal to about 1.6 and optionally less than or equal to about 1.5. As noted above and will be appreciated by those of skill in the art, in certain aspects, so long as the high refractive index core has a refractive index (n_{H}) that is greater than the refractive index (n_{L}) of the low refractive index layer, the values themselves may not be determinative

In certain variations, the low refractive index material of the upper and/or lower cladding layers 54, 52 may be formed of a soft and imprintable polymer. The relatively soft and imprintable polymer may be a liquid comprising a polymeric precursor that is curable when exposed to ultraviolet (UV)-radiation. As described herein, a “flexible” material may be used for a flexible mold for the imprinting process, which in certain aspects, is advantageous over the rigid mold, as it can bend around dust particles and avoids creating large defective areas. Thus, such a flexible mold can be made of PUA material alone. In other variations, it may be formed of a high modulus surface layer bonded with a lower modulus “carrier” layer, for example, a high modulus polydimethylsiloxane (PDMS) disposed over a conventional PDMS. Notably, while the cladding layer having the imprinted trench may be soft and is imprintable, it does not necessarily need to have specific modulus, because it only serves as a template for the spin-coated polymer core material. By a soft, imprintable, or flexible material, it is meant that the material may have a “Young's modulus” or mechanical property referring to a ratio of stress to strain for a given material provided by the expression:

E=((stress))/((strain))=σ/ϵ=LO/ΔL×F/A,

where engineering stress is σ, tensile strain is ϵ, E is the Young's modulus, LO is an equilibrium length, ΔL is a length change under the applied stress, F is the force applied and A is the area over which the force is applied. In certain aspects, a soft and imprintable material has a Young's modulus (E) of less than or equal to about 3 GPa, optionally less than or equal to about 2.5 GPa, optionally less than or equal to about 2.3 GPa, optionally less than or equal to about 2 GPa, optionally less than or equal to about 1.5 GPa, and in certain variations, optionally less than or equal to about 1 GPa. A suitable example includes polyurethaneacrylate (PUA) having a Young's modulus (E) of about 2.3 GPa.

Thus, in certain variations, a particularly suitable low refractive index soft and imprintable polymer is polyurethaneacrylate (PUA), having a refractive index (n) of about 1.49 and Young's modulus of about 2.3 GPa, which may be transparent to visible light. A suitable, UV-curable PUA may be MINS-311RM, sold by Minuta Technology Co., Ltd. Other suitable low refractive index cladding materials may include transparent (e.g., to wavelengths of light in the visible range) fluoropolymers, such as CYTOP™ commercially available from AGC Chemicals, with a refractive index (n) of about 1.34. In alternative variations, the lower or upper cladding layers 52, 54 may be formed of an aerogel, such as a silicon dioxide (SiO₂) aerogel. While the term “aerogel” is used herein, generally referring to a gel having a plurality of pores or open voids filled with air, another medium or composition (e.g., gaseous, vapor, liquid, or semi-liquid/gel) may fille the pores. In this manner, the body of the material may have a first refractive index and the medium(s) occupying at least a portion of the open volume of the pores may have a second refractive index that may together define an overall or cumulative refractive index of the porous material, which may thus define a cumulatively low refractive index. In certain aspects, the aerogel may be formed, as described further herein by using a liquid precursor that comprises cross-linked molecules that can form a porous network when the final aerogel network is formed.

The lower cladding layer 52 and upper cladding layer 54 may be relatively thick layers and have independent thicknesses from one another or the same thicknesses. Generally, thicker cladding layer(s) are advantageous. As will be appreciated by those of skill in the art, thickness strongly depends on a wavelength used in operation, such that for longer wavelengths, the cladding layer(s) are thicker. For example, each of the lower cladding layer 52 and upper cladding layer 54 may independently have a thickness of greater than or equal to about 2 micrometers (μm), optionally greater than or equal to about 3 μm, optionally greater than or equal to about 4 μm, optionally greater than or equal to about 5 μm, and in certain variations, greater than or equal to about 6 μm.

In certain variations, the high refractive index material of the core 50 may be formed of a solid polymer is selected from the group consisting of: polystyrene (PS) having a refractive index (n) of about 1.58, polycarbonate (PC) having a refractive index (n) of about 1.57, an epoxy-based photoresist, such as commercially available resist SU-8 sold by MicroChem, which is a negative tone photoresist high contrast epoxy-based material having a refractive index (n) of about 1.57, and combinations thereof. In certain variations, the core 50 may be formed of solid polystyrene (PS).

The core 50 may have a height in a trench of the lower cladding layer that is greater than or equal to about 1 micrometer (μm), optionally greater than or equal to about 1.1 μm, optionally greater than or equal to about 1.2 μm, optionally greater than or equal to about 1.3 μm, and in certain variations, optionally greater than or equal to about 1.4 μm. A width of the core 50 in the trench may be greater than or equal to about 1.9 micrometer (μm), optionally greater than or equal to about 2 μm, and in certain variations, optionally greater than or equal to about 2.1 μm.

As will be described further below, in certain variations, the core 50 is formed in a trench or channel defined in the lower cladding layer that may define a microfeature, for example, having a trapezoidal or rectangular cross-sectional shape, such as an inverse isosceles trapezoidal shape, by way of example. The core 50 comprises a solid polymer that is heated (e.g., annealed) for thermal reflow, such that the solid polymer dewets and/or retracts from a surface of the lower cladding layer. In certain aspects, the thermal reflow further defines a solid polymer surface having a meniscus shape, meaning that in the trench or channel, it defines a shape at the upper surface that is curved, for example, concave where the edges of the surface at each side of the channel are higher than a central region of the core 50. In certain variations, the solid polymer may be disposed in the channel or trench of the lower cladding layer at a predetermined fill ratio, which in certain aspects, can be measured as filling ratio (f) that is a ratio of depth (d) over height (h) (f=d/h). In certain variations, a solid polymer is disposed in the trench or channel at a fill ratio of greater than or equal to about 0.7, optionally greater than or equal to about 0.8, and in certain variations, optionally greater than or equal to about 0.9. For certain structures, when a fill ratio (f) is greater than or equal to about 0.7, a radiation loss is less than about 1 dB and corresponds to an approximate 280,000 intrinsic Q-factor.

In certain variations that will be described further herein, the present disclosure provides an organic microring resonator optic structure comprising a first polymeric cladding layer disposed on a substrate having at least one trench microfeature, wherein the first polymeric cladding layer has a first refractive index. A second material having a second refractive index, such as a solid polymer, is disposed in the at least one trench microfeature. The second material/solid polymer defines a meniscus. A difference between the first refractive index and the second refractive index is greater than or equal to about 0.05. A second polymeric cladding layer is disposed over the second surface and the solid polymer in the at least one trench microfeature. The solid polymer is disposed in the at least one trench microfeature and defines a waveguide of the microring resonator embedded in the first polymeric cladding layer and the second polymeric cladding layer. The microring resonator has a quality (Q)-Factor of greater than or equal to about 1×10⁵ at a wavelength of about 770 nm, optionally greater than or equal to about 2×10⁵, optionally greater than or equal to about 3×10⁵, optionally greater than or equal to about 4×10⁵, and in certain variations, optionally greater than or equal to about 5×10⁵, and can optionally exceed 1×10⁶ at a wavelength of about 770 nm.

The second material/solid polymer may be one that can be formed via a liquid precursor, for example, it may be dissolved or suspended in a liquid. In certain variations, the liquid polymeric precursor comprises of one or more polymer precursors or components dissolved in a solution comprising a solvent or other liquid carriers. The liquid polymeric precursor may thus be spin cast or otherwise applied to the surface of the lower cladding so that it at least partially fills the microfeature defined thereon. The solid polymer may be a thermoplastic or thermoset. In certain aspects, the solid polymer may be selected from the group consisting of: thermooptic polymers, electrooptic polymers, photothermal polymers, photoelastic polymer, polymers comprising dyes or quantum dots, composites comprising a plurality of nanoparticles with a high refractive index (e.g., inorganic nanoparticles), and any combinations thereof. A thermoptic polymer refers to a polymer that exhibits refractive index change with temperature. Examples of thermooptic polymers include polystyrene and polycarbonate. An electro-optic polymer refers to a polymer that exhibits refractive index changes with the applied voltage, such as AJ-CKL1 or AJSP1002, by way of example. Photothermal polymers refers to polymers that exhibit a light-to-heat conversion, such as poly-2-phenyl-benzobisthiazole (PPBBT), by way of non-limiting example. A photoelastic polymer generally refers to a polymer that exhibits a refractive index change with pressure. Suitable examples of photoelastic materials include polycarbonate and polystyrene. In other variations, the polymer may comprise quantum dots, such as a polystyrene doped with cadmium telluride (CdTe) or polystyrene doped with zinc selenide (ZnSe).

In certain aspects, the solid polymer may be selected from the group consisting of: polystyrene (PS), polycarbonate (PC), polymethylmethacrylate (PMMA), epoxy-based resin, such as an epoxy-based photoresist, silsesquioxane resin, electrooptic polymers, thermooptic polymers, photothermal polymers, photoelastic polymers, a polymer comprising a dye or a quantum dot, a composite comprising a nanoparticle (e.g., an inorganic nanoparticle), and combinations thereof. In certain variations, the solid polymer is selected from the group consisting of: polystyrene (PS), polycarbonate (PC), epoxy-based photoresist, and combinations thereof. In certain further aspects, the first polymeric cladding and the second polymeric cladding respectively comprise polyurethaneacrylate (PUA) and the solid polymer comprises polystyrene (PS). In other variations, the solid polymer may be a composite material, for example, comprising a plurality of nanoparticles (e.g., inorganic nanoparticles) distributed in a polymeric matrix to define the high refractive index material. The nanoparticles may be formed of high-refractive index materials, such as titanium dioxide (TiO₂), zirconia or zirconium dioxide (ZrO₂), lead sulfide (PbS), silicon (Si), vanadium pentoxide (V₂O₅), graphene oxide, and equivalents and combinations thereof. In one variation, the nanoparticles may have an average particle size of less than or equal to about 25 nm.

The second surface of the first cladding layer 52 is substantially free or free of any residual solid polymer having the second refractive index. The term “substantially free” as referred to herein means that the residual core material/solid polymer is absent to the extent that that undesirable and/or detrimental effects attendant with its presence are avoided, such as low quality (Q)-factor, high radiation loss, and the like. In certain embodiments, a surface that is “substantially free” of the residual solid polymer comprises less than about 15% of the surface area of the surface being covered by residual polymer (in this case, surface regions external to the at least one trench microfeature on the first cladding layer 52), more preferably less than about 10%, optionally less than about 5%, more preferably less than about 4%, optionally less than about 3%, optionally less than about 2%, optionally less than about 1%, optionally less than about 0.5%, and in certain embodiments, is fully free and comprises 0% of the surface area of the surface being covered by residual polymer. For example, the regions external to the trench on the second surface of the first cladding layer 52 after the annealing heat treatment are substantially free or free of residual polymer that has retracted into the trench to define the core region 50.

As will be described further herein, this removal of residual polymeric material on the surface can be achieved without any physical or chemical removal process, leaving the sidewalls with a relatively smooth surface having low surface roughness. Moreover, heat treatment that anneals the polymeric material disposed in the trench microfeature(s) for thermal reflow helps to define a meniscus with greatly reduced surface roughness. Generally, a roughness of the sidewall as described herein refers to the interface between the cladding layer and the core layer. Further, a surface roughness of the polymer along the meniscus may be relatively smooth after thermal reflow. In certain variations, a surface roughness may be measured by a root mean squared (RMS) surface roughness (e.g., from peaks to valleys) that is less than or equal to about 2% of the total layer thickness, optionally less than or equal to about 1% of the total layer thickness, optionally less than or equal to about 0.5% of the total layer thickness, and in certain aspects, optionally less than or equal to about 0.1% of the total layer thickness. For example, in certain aspects, the sidewall at the lower cladding layer and core may have a surface roughness of less than or equal to about 10 nanometers (nm) root mean squared (RMS), where an overall thickness of the cladding layer is at least about 1 micrometer (μm). It should be noted that another way of creating a waveguide core region/filling without incurring residual layers is by introducing the precursor material into the trench region only, e.g. by inkjet printing precursor droplets into the cladding trench regions.

The substrate may comprise a flexible polymer, such as polyethylene terephthalate (PET).

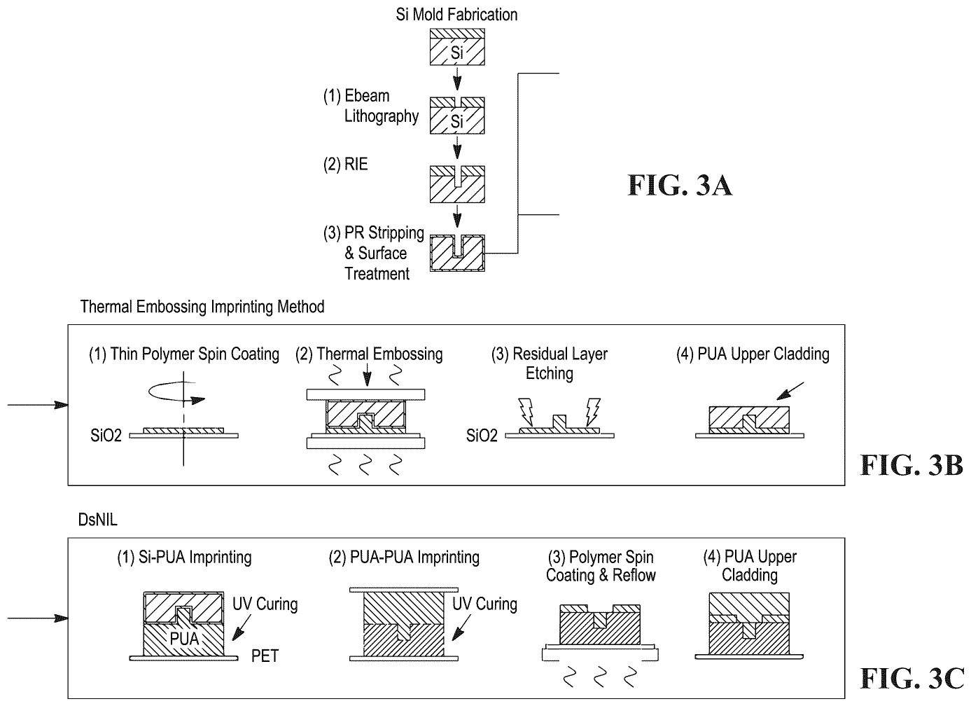

The present disclosure contemplates methods of making templated optical structures, such as cladded organic optic structures like an optical microring resonator. By way of example, such a process is shown in FIG. 3C as steps (1) to (4). In certain aspects, as shown in step (1), the method comprises patterning a first surface of a moldable polymer (e.g., PUA) disposed on a first substrate that may be formed of a rigid material, such as polyethylene terephthalate (PET). The patterning occurs by contacting a rigid inverse mold having at least one trench microfeature with the first surface of the moldable polymer so as to define at least one inverse trench microfeature in the first surface of the moldable polymer. A trench may be considered to be an elongated structure, such as an elongated depression, void, or channel that will define a shape or inverse shape of an optic structure (e.g., a linear waveguide or ring/circle) within the cladded organic optic structure. As described above, the trench may have a trapezoidal or rectangular cross-sectional shape where one side is fully open.

A “microfeature” as used herein encompasses “nanofeatures,” as discussed below. In certain variations of the present teachings, a microfeature has at least one spatial dimension that is less than about 1,000 um (i.e., 1 mm) and optionally less than or equal to about 100 um (i.e., 100,000 nm). The term “micro-sized” or “micrometer-sized” as used herein is generally understood by those of skill in the art to mean less than about 500 micrometers ((μm) or 0.5 mm). As used herein, a microfeature has at least one spatial dimension that is less than about 25 μm (i.e., 25,000 nm), optionally less than or equal to about 20 μm (i.e., 20,000 nm), optionally less than or equal to about 15 μm (i.e., 15,000 nm), optionally less than or equal to about 10 μm (i.e., 10,000 nm), optionally less than about 5 μm (i.e., 5,000 nm), optionally less than about 3 μm (i.e., 3,000 nm), optionally less than about 2 μm (i.e., 2,000 nm), and in certain aspects less than or equal to about 1 μm (i.e., 1,000 nm).

A nanofeature has at least one dimension in the nanoscale, for example, at least one spatial dimension is less than about 1 μm (i.e., 1,000 nm), optionally less than about 0.5 μm (i.e., 500 nm), optionally less than about 0.4 μm (i.e., 400 nm), optionally less than about 0.3 μm (i.e., 300 nm), optionally less than about 0.2 μm (i.e., 200 nm), and in certain variations, optionally less than about 0.1 μm (i.e., 100 nm). Accordingly, a nanofeature may have at least one spatial dimension that is greater than or equal to about 1 nm and less than or equal to about 1,000 nm (1 μm). It should be noted that so long as at least one dimension of the micro/nano-feature falls within the above-described micro-sized and/or nano-sized scales (for example, width or height), one or more other dimensions may well exceed the micro-or nano-size (for example, length).

In certain non-limiting variations, the microfeature may be the size of a waveguide on the order of the wavelength of light traveling inside. For example, the microfeature may be a trench, for example, defining a bus waveguide or a ring, with a width of greater than or equal to about 2.1 μm to less than or equal to 5 μm and a depth of about 1.4 μm, respectively. The present methods may also form nanofeatures, for example, the coupling region of a microring waveguide and a bus waveguide, as shown in FIGS. 1 and 2, as gap 42 disposed between the linear bus waveguide 30 and a portion of the circular ring 40, which may be approximately 100 nm to a few hundred nanometers (e.g., up to about 300 nm) thick. Thus, while the waveguide trench may be larger, the feature formed between the linear waveguide and circular ring may be on a nanoscale.

The rigid inverse mold may be formed of silicon (Si), for example, and the microfeatures may be formed on a surface via typical mold nanofabrication procedures, such as e-beam lithography, and reactive ion etching, as will be described in more detail below with respect to FIG. 3A. The microfeatures on the rigid mold may thus form a pattern on the moldable polymer (e.g., PUA) so as to define at least one inverse trench microfeature, meaning that a protrusion or ridge is formed in the moldable polymer.

In certain aspects, the moldable polymer is a liquid comprising an ultraviolet radiation (UV)-curable polymer precursor, so that the patterning of the first surface of the moldable polymer further comprises applying ultraviolet (UV) radiation to cure and solidify the liquid to form a solid moldable polymer during the contacting with the rigid inverse mold. The moldable polymer is applied in a relatively thick layer on the substrate so that it receives the microfeature(s) and can be separated from the rigid mold without physical or mechanical damage. After separating the rigid mold, the moldable polymer has a first surface with the at least one inverse trench features defined therein.

Next, at (2), the first surface of the moldable polymer having the at least one inverse trench microfeature is imprinted into a second surface of a first polymeric cladding layer disposed on a second substrate. The second substrate may be a flexible substrate. The first polymeric cladding may likewise be formed of a moldable polymer. The first polymeric cladding layer has a first refractive index, which as described above may be a low refractive index. The first polymeric cladding layer may comprise PUA or other materials, such as CYTOP™ fluoropolymer, an aerogel, such as silicon dioxide (SiO₂) aerogel, and the like. In this manner, by contacting and imprinting the second surface with the inverse trench microfeature (e.g., the protrusion or ridge), the at least one trench microfeature contrapositive to the at least one inverse microfeature (e.g., protrusion or ridge) is defined in the second surface. In certain aspects, the moldable polymer forming the first cladding layer is a liquid comprising an ultraviolet radiation (UV)-curable polymer precursor, so that the patterning or imprinting of the first surface of the moldable polymer further comprises applying ultraviolet (UV) radiation to cure and solidify the liquid to form a solid first polymeric cladding layer having the at least one trench microfeature in the second surface. Again, the moldable polymer forming the first cladding layer is applied in a relatively thick layer that receives the imprinted first surface of the moldable polymer and can be separated from the moldable polymer and first substrate without physical or mechanical damage.

Next, a liquid polymeric precursor is applied at (3) into the at least one trench microfeature on the second surface of the first polymeric cladding layer. In certain aspects, the liquid polymeric precursor may be spin coated or cast onto the second surface so that it fills the at least one trench microfeature. Other variations of applying are also contemplated, such as ink-jet printing, aerosol jet printing, electrohydrodynamic (e-jet or EHD) printing, or photoacoustic printing of the liquid polymeric precursor into the at least one trench microfeature. Thus, the viscosity of the liquid polymeric precursor is selected to permit spin casting/coating or alternatively printing. The spin casting may occur in a single step or alternatively, in two or more steps, so that two or more layers of the liquid polymeric precursor are applied. The method includes solidifying the liquid polymeric precursor to form a solid polymer having a second refractive index. The difference between the first refractive index and the second refractive index is greater than or equal to about 0.05, for example where a microring has a radius of less than about 100 μm or the other differences specified previously above. The solid polymer thus defines the core at least partially embedded within the second surface of the first polymeric cladding layer.

Further, the method may include heating (e.g., annealing) the solid polymer for thermal reflow in the at least one trench microfeature. By annealing, it is meant that heat is applied to the solid polymer, but the solid polymer is only heated to below its glass transition temperature and/or melting point, so that thermal reflow occurs. The thermal reflow results in the solid polymer dewetting from the surface of the cladding layer near the trench edges, without requiring any chemical or mechanical removal processes. Further, the thermal reflow defines a meniscus shape having a smooth surface (due to the surface tension) of the solid polymer within the trench or channel. Suitable temperatures and times for heating depend upon the polymer used to form the solid polymer in the core region. In one non-limiting variation, the solid polymer is polystyrene and the solid polymer may be heated in an environment having a temperature of about 115° C. for about 3 minutes. In another variation, the solid polymer comprises polycarbonate or an epoxy-based resist and the solid polymer may be heated in an environment having a temperature of about 170° C. for about 3 minutes. At a temperature near or above the polymer's glass transition temperature (T_{g}), the polymer becomes a viscous liquid and the surface tension can smooth out any roughness to minimize the overall surface energy of the system. Thus, the thermal reflow allows the polymer to reflow and initiates the onset of the retraction from the lower cladding surface. Further, the spin coated polymer becomes smooth. For this annealing process, the precursor of the solid polymer is exposed to a temperature that is slightly higher than the glass transition temperature of the spin coated polymer (for example, about 100° C. for polystyrene polymer and about 150° C. for polycarbonate). However, as will be appreciated, the temperature id not so high as to melt the lower cladding layer material (e.g., formed of PUA). In one variation, the precursor of the solid polymer is exposed to a temperature of about 180° C. for this annealing/reflow process and there was advantageously no significant change of the PUA cladding layer. In certain aspects, the annealing for thermal reflow and retraction of the polymer from the cladding surface outside of the trench is conducted at a temperature of less than or equal to about 175° C., optionally less than or equal to about 170° C., optionally less than or equal to about 165° C., optionally less than or equal to about 160° C., optionally less than or equal to about 155° C., optionally less than or equal to about 150° C., optionally less than or equal to about 145° C., optionally less than or equal to about 140° C., optionally less than or equal to about 135° C., optionally less than or equal to about 130°° C., optionally less than or equal to about 125° C., optionally less than or equal to about 120° C., and optionally less than or equal to about 115° C. The annealing may be conducted for less than or equal to about 20 minutes, optionally less than or equal to about 15 minutes, optionally less than or equal to about 10 minutes, optionally less than or equal to about 5 minutes, optionally less than or equal to about 4 minutes, and in certain variations, optionally less than or equal to about 3 minutes.

At step (4), the second polymeric cladding layer may then be applied over the solid polymer disposed within the at least one trench microfeature in the second surface of the first polymeric cladding layer. The second polymeric cladding may likewise be formed of a moldable polymer. The second polymeric cladding layer has a third refractive index, which as described above may be a relatively low refractive index to contrast with the relatively high refractive index of the core region material. The first and third refractive indices may be the same or alternatively, different from one another. The second polymeric cladding layer may comprise PUA. In this manner, the solid polymer disposed in the at least one trench microfeature defines an optic feature embedded in the first polymeric cladding layer and the second polymeric cladding layer.

In certain aspects, the moldable polymer forming the second cladding layer is a liquid comprising an ultraviolet radiation (UV)-curable polymer precursor, so that after the applying, ultraviolet (UV) radiation can be applied to cure and solidify the liquid to form a solid second polymeric cladding layer.

In certain variations, the second cladding layer is formed from (i) a liquid comprising an ultraviolet radiation (UV)-curable polymer precursor, where the applying further comprises applying ultraviolet (UV) radiation to cure the liquid to form a solid second polymeric cladding layer. Alternatively, the second cladding layer may be formed from (ii) a liquid comprising a thermoset polymer precursor, where heat is applied to cure the liquid to form a solid second polymeric cladding layer. In yet another aspect, (iii) a liquid may comprise a thermoplastic polymer, where heat is applied or solvent evaporated to form a solid second polymeric cladding layer. In yet another aspect, the second cladding layer is formed from (iv) a liquid that may comprise cross-linked molecules, so that the solidifying of the liquid forms an aerogel material as the second cladding material. The aerogel material has a porous network of the cross-linked molecules and a low refractive index.

In certain aspects, the moldable polymer comprises polyurethaneacrylate (PUA), the first polymeric cladding and the second polymeric cladding respectively comprise polyurethaneacrylate (PUA), and the solid polymer comprises polystyrene (PS).

Such a fabrication method is referred to as DsNIL, which can be considered a new Photonics Damascene Process, where a template is created by soft nanoimprinting lithography (sNIL) that is subsequently filled with a polymer. The damascene process is named after the ancient metal working technique developed in Damascus, Syria, and in modern history has been used to pattern metals, such as the copper interconnector in the semiconductor industry, by first creating a trench template and subsequently filling it with copper. sNIL is a high throughput, low-cost nanopatterning lithography that has also been used to fabricate microring resonators. However, the Q-factor is limited in such microring resonators due to the presence of a residual layer, which leads to excess radiation loss. For the present methods, the damascene process strategy is instead used to pattern the cladding structure first and then backfilling with a higher refractive index polymer to form a waveguide core. In such methods, the sNIL is used for high throughput patterning of the microring cladding layer trenches. After patterning, a simple polymer spin coating is applied to fill the trench and functions as the waveguide core. Annealing occurs for thermal reflow, which is then applied to smooth the polymer core and form or smooth the desired meniscus shape. During thermal reflow and annealing, the high refractive index polymer will gradually form a meniscus shape in the trench with a smooth surface by the surface tension and with no residual layer nearby. Thus, the residual layer of solid polymer defining the core region (e.g., microring resonators or waveguides) also spontaneously retracts from the edges. This phenomenon can also be understood as a means to reduce the overall surface energy of the regions next to the trench pattern. After annealing, resulting in a residual layer-free structure.

In certain aspects, the present disclosure contemplates a method of making a templated optical structure. A templated optical structure may include a cladded organic or polymeric optic structure, such as a microring resonator, meta-elements, and the like or other photonic structures having high-refractive index contrast. For example, the process is especially advantageous for fabricating high aspect ratio structures, such that in metasurfaces. The method may comprise patterning a first surface of a moldable polymer disposed on a first substrate by contacting a rigid inverse mold having at least one trench microfeature with the first surface of the moldable polymer to define at least one inverse trench microfeature in the first surface. The method also comprises imprinting the first surface of the moldable polymer having the at least one inverse trench microfeature into a second surface of a first polymeric cladding layer disposed on a second substrate to replicate the at least one trench microfeature contrapositive to the at least one inverse trench microfeature in the second surface. The first polymeric cladding layer has a first refractive index. The method also comprises applying a liquid polymeric precursor into the at least one trench microfeature on the second surface of the first polymeric cladding layer and solidifying the liquid polymeric precursor to form a solid polymer having a second refractive index. A difference between the first refractive index and the second refractive index is greater than or equal to about 0.05.

As described above, in certain aspects, the method further comprises heating the solid polymer to facilitate retraction from regions of the second surface external to the at least one trench microfeature and annealing for thermal reflow of the solid polymer in the at least one trench microfeature.

In certain aspects, the method further comprises applying a second polymeric cladding layer over the solid polymer in the at least one trench microfeature in the second surface of the first polymeric cladding layer. The solid polymer is disposed in the at least one trench microfeature defines an optic feature embedded in the first polymeric cladding layer and the second polymeric cladding layer.

In certain aspects, the method further comprises selectively removing the first polymeric cladding layer, for example, by etching while leaving the solid polymer having the second refractive index intact. In this manner, the templated optical structure is formed, for example, it may be an array of optical elements with greater refractive index contrast.

Various embodiments of the inventive technology can be further understood by the specific examples contained herein. Specific Examples are provided for illustrative purposes of how to make and use the compositions, devices, and methods according to the present teachings and, unless explicitly stated otherwise, are not intended to be a representation that given embodiments of this invention have, or have not, been made or tested.

### EXAMPLES

The fabrication process begins with making a silicon (Si) master mold by E-beam lithography (JBX-6300FS, JEOL) with positive tone resist ZEP520-A to define the microfeatures, in this case, microring patterns. After writing and development, the E-beam resist underwent 180 seconds of thermal reflow at 150° C. to harden the resist. The defined pattern was then sent into an ICP-based Si etcher (9400 SE, LAM) with HBr as the silicon etching gas with TCP power 600 W. The etched silicon was then immersed in buffered hydrofluoric acid (BHF) and nanostrip to remove the residual resist. To further reduce the sidewall roughness, the Si mold was annealed at 1100° C. (Tempress furnace) for 1 hour to oxidize the fabricated Si mold. The resulting SiO₂ on the Si mold surface was approximately 100 nm thick. The entire mold was then immersed in BHF to remove the oxidized SiO₂. Finally, the mold was plasma treated and incubated with the anti-sticking agent (Perfluorooctyl trichlorosilane, Thermal Scientific) in a closed chamber at 150° C. for 1 hr. The resulting Si mold can be covered by an anti-stick monomer and can effectively reduce the surface energy.

After fabricating the Si mold with a patterned surface, the PUA soft mold on a PET substrate is made with an inverse pattern of the microfeatures from the Si mold. First, spin coating (3000 rpm, 45 seconds) of uncured PUA liquid (RM311, Minuta Tech) occurs on a urethane-coated PET film. The resulting PUA was measured to be about 7 μm thick. The fabricated Si mold was then placed on the PUA/PET film and a roller was used to squeeze the air out from the gap to ensure a good contact. Afterward, UV light (ECE 5000, Dymax) of 225 mW/cm2 was applied for 180 seconds to cure the PUA. After curing, the PUA/PET film could be easily peeled off from the Si mold due to the low surface energy between the Si mold and PUA. The resulting PUA/PET film was evaluated under a microscope to ensure no defects.

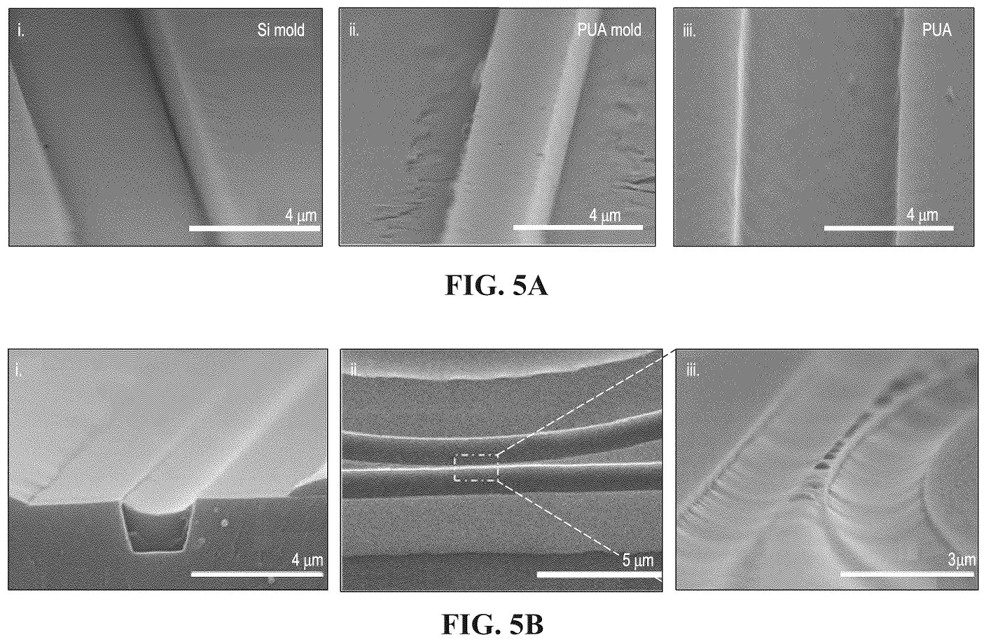

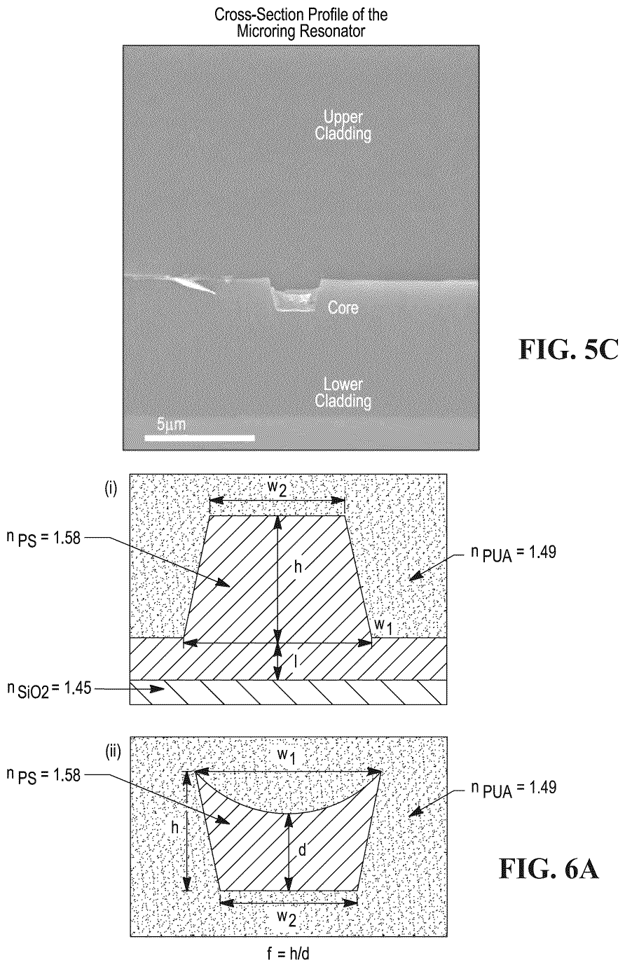

With the PUA/PET soft mold, this soft mold is then used for self-replication to pattern the PUA cladding layer of the microring resonators. An adhesion promoter (glass primer, Minuta Tech) to improve PUA adhesion was first spin-coated on the desired substrate and baked at 115° C. for 3 min. PUA was then spin-coated (3000 rpm) on a treated substrate to create a 7-μm PUA layer. The PUA soft mold was then placed on the substrate for soft nanoimprinting by following a similar process as described above. Afterward, 180 seconds of UV light was applied to cure the PUA. After curing, the mold and the substrate were separated. After fabricating the PUA cladding on the Si substrate, a core material precursor of 10% of polystyrene (M.W. 50,000, Polysciences)/toluene solution was spin-coated at 3000 rpm on the substrate with patterned PUA. The PUA/polystyrene substrate was then placed on a hot plate for 3 minutes to allow the polymer to reflow inside the trench. The polymer filling and the retraction of the residual layer can be checked under a microscope. The spinning speed, annealing temperature and annealing time may vary with polymers and the patterned trenches. In certain variations, the annealing temperature was 115° C. for PS and 170° C. for PC and SU8-2000.5 epoxy-based polymer. Three minutes was sufficient for PC, PS and SU8-2000.5. No polymer filling defects was seen in the experiments. However, slight variation of polymer filling ratio might occur according to FIG. 5C and could influence the critical coupling conditions. This was solved by fabricating multiple lines with different gaps of microring to bus waveguide to ensure reaching the critical coupling condition. Finally, PUA was spin-coated again to create the upper cladding layer. After curing for 3 minutes, the entire cladded device was formed. A clear end-facet can be prepared by directly cleaving the Si substrate or sculpture to cut the soft substrate.

The spectral measurement setup included a tunable laser (TLB 6312, Newfocus) used as the light source. The laser was operated at a constant power mode and scanned from 770 nm to 773 nm at a constant speed of 1 nm/s and then coupled into a single-mode fiber (P3-780A-FC-2, Thorlabs) and the polarization controller (FPC033, Thorlabs) to ensure the TE polarization. Both the fiber and the waveguide end-facets were cleaved for fiber-chip edge coupling. The end-facet of the waveguide was tapered to 5 micrometers (μm) in width to match the mode diameter of the fiber. The other end of the waveguide was edge coupled to a multi-mode fiber (M122L02, Thorlabs) with a diameter of 200 μm. The overall measured fiber coupling efficiency was approximately 15%. The multi-mode fiber was connected to a high-speed photodetector (1601-AC, Newfocus) for optical detection and connected to an oscilloscope to record the output change. On top of the microring resonators, an objective lens and a camera were used to image the microring resonator. When light was tuned to the resonant wavelength, the corresponding microring resonator would light up. With this method, 4 sharp dips within each FSR were identified from the 4 different microring resonators, respectively.

The simulation of the mode distribution and radiation loss was calculated by using commercial FDTD software (Ansys Lumerical). The parameters used in the simulation were based on the experimental data. The refractive index of polystyrene and PUA are obtained by ellipsometer (M-2000, J. A. Woollam) with B-spline fitting. The dimension of the mirroring resonators was measured by SEM (SU8000, Hitachi). To obtain a correct numerical value, the cladding layer was set to thick enough and the boundary was set as a perfectly matched layer to avoid introducing numerical errors.

To better understand the DsNIL method, the fabrication procedure of the traditional thermal-embossing-based nanoimprinting method and DsNIL were compared. For both methods, the fabrication can begin with a rigid mold fabrication, for example, made of silicon as FIG. 3A shows. The Si mold is usually defined by E-beam lithography with high precision and then etched by the reactive ion etching (RIE) method. After etching, the rigid mold undergoes resist stripping and surface functionalization to reduce the surface energy.

For a traditional thermal embossing NIL method, as shown in FIG. 3B, the fabrication starts with the spin-coated thin polymer materials (approximately 300 nm thickness) on a silicon dioxide (SiO₂) layer disposed over a silicon (Si) substrate and is followed by high-pressure thermal embossing imprinting (e.g., 600 psi pressure) with elevated temperature (180° C.) for several minutes. This step typically requires dedicated nanoimprinter tools to uniformly apply high pressure and temperature on the samples to force the spin-coated thin polymer into the mold trenches, and therefore form waveguide cores with the needed height. In this imprinting process, the underlying residual polymer layer is as thick as the initial polymer thickness. Therefore, typically a RIE process is needed to remove the residual layer outside of the regions where the polymer should remain, which can impart surface roughness to the polymer core. Finally, the upper-cladding material is spin-coated on top of the device to serve as an upper-cladding layer for the protection of the imprinted microring and bus waveguides. A UV-cured PUA soft mold has sufficient rigidity and can ensure high pattern fidelity during nanoimprinting without pattern collapse. The high-resolution can also faithfully replicate the pattern from the original rigid (Si) mold without introducing additional roughness. Therefore, highly smooth organic microring resonator optic structures can be formed through optimizing the silicon (Si) mold fabrication process. The highly smooth sidewall ensures low scattering loss and thus high Q-factor organic microring resonator optic structures.

As described above, FIG. 3C demonstrates one embodiment of the DsNIL methods provided by certain aspects of the present disclosure that uses polyurethane acrylate (PUA) as a soft NIL mold. After an original rigid silicon (Si) mold is fabricated with E-beam lithography and RIE to have a patterned surface defining at least one trench structure, its inverse pattern is reproduced in a PUA mold on a flexible PET substrate, which is made by UV imprinting the PUA with the Si mold. The fabricated PUA on PET soft mold is then used by a second sNIL process to replicate the waveguide pattern into another PUA layer coated on a chosen substrate. The patterned PUA layer on the substrate now has the same pattern as that on the original Si mold and will serve as the lower cladding layer (e.g., n=1.49 with a wavelength of 780 nm) of the microring resonator. The high-index polymer solution is then spun on top of the trench patterns in the PUA layer, followed by thermal reflow via annealing to allow the high refractive-index polymer to re-shape in the PUA trench to serve as the microring and waveguide core. During thermal reflow, the meniscus-shaped high-index polymer will gradually form smooth surface by the surface tension and with no residual layer nearby. Therefore, advantageously, no residual layer etching step is needed. Finally, another PUA layer is coated as the upper cladding layer. The entire process can be conducted without the use of special equipment or instruments, such as lithography, and etching tool, and can be easily done in a regular lab environment without the need for a clean room (e.g., minimal dust or dust-free environment).

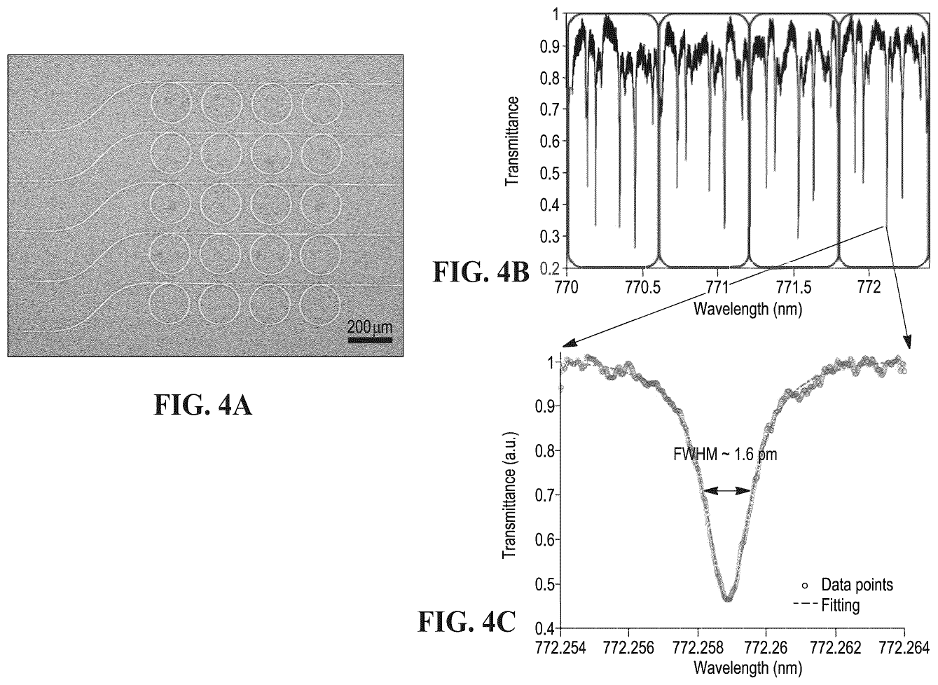

The quality factor (Q-Factor) of a microring resonator fabricated by such an inventive DsNIL method is tested. A tunable laser with a central wavelength of about 773 nm is used as the input light source. A fiber polarization controller is used to maintain the TE polarization of the laser output. A single-mode fiber with a cleaved end-facet is used to couple the laser into the bus waveguide. To facilitate coupling efficiency, the bus waveguide is tapered to 5 μm in width. The opposite end of the waveguide is connected to a multimode fiber to collect the light transmitted through the device, which is focused onto a photodetector for power readout. By tuning the laser wavelength, the microring resonator spectrum can be obtained. FIG. 4A shows the SEM image of the fabricated microring resonators (before polymer filling). The width and the depth of the ring and the bus waveguide are 2.1 and 1.4 μm respectively.

Five sets of microring resonators with different gaps (100 to 300 nm, with 50 nm increments) are fabricated and tested. In each set, there are 4 microrings with a radius close to 100 μm. A small variation of radius between each ring is introduced to produce a slightly different resonant wavelength for each microring. FIG. 4B plots the measured transmission spectrum of the 4 microring resonators with filling height of about 1.28 μm (filling ratio=90%), and a bus to waveguide gap of about 150 nm. The free spectral range (FSR) of 100-μm radius is approximately 0.6 nm, as indicated with the boxes in the figure. Within each FSR, 4 sharp dips that correspond to the TE mode of the 4 microring resonators can be identified. The tunable laser scans across the wavelength, where the microring resonator that is on resonance will light up and can be identified under a CCD. There are other secondary dips shown on the spectrum, which correspond to the TM modes of the resonance. Those components can be suppressed by using polarization-maintained fiber. FIG. 4C shows the spectrum with a fine scan and with a Lorentzian fit. The measured full width at half maximum is approximately 0.16 pm, corresponding to a Q-factor of approximately 480,000, believed to be comparable to the best-nanoimprinted polymer microring resonators made previously. The measured intrinsic Q-factor is 570,000, corresponding to a propagation loss of approximately 0.55 dB/cm.

The Q-factor based on the devices formed via the inventive DsNIL methods is comparable to the current record of polymer microring resonator fabricated by conventional NIL with a Q-factor of approximately 600,000. The attainable Q-factor is intrinsically limited by absorption, radiation, and scattering loss in the microring waveguide. The absorption loss is negligible due to very low absorption by polystyrene of the material, and the radiation loss of the microring is only about 0.1 dB/cm based on the simulation detailed below. Therefore, the scattering loss can be estimated to be about 0.45 dB/cm. This scattering loss can be attributed to the surface roughness of the Si mold. Additionally, a spectral stability test is conducted by immersing the microring resonator under water for 1 hr. and measuring the spectral change. Within the 1 hour, no significant spectral change but a slight wavelength shift occurs, indicating the robustness of the microring resonator. This indicates the PUA upper and lower cladding layer can serve as a protection layer to prevent the microring resonator from dust contamination. The resonant wavelength shift is attributed to the temperature-induced spectrum shift.

The high Q-factor exhibited by these microrings can be attributed to the suppressed ring waveguide loss. FIGS. 5A to 5C show SEM images of formed cladded structures, including of the side wall roughness and the residual layer-free of the microring resonator. Common optical losses of polymer microring resonators are scattering loss due to sidewall roughness and the radiation loss due to the residual layer (i.e., limited mode confinement). In sNIL, the surface roughness of the microring usually inherits from the roughness of the master Si mold and the low pattern fidelity during imprinting. The Si rigid master mold can be treated to have low surface roughness by using HBr-based Si dry etching and use of thermal oxidation to further smooth the surface. The SEM image of the sidewall of the Si mold is shown in FIG. 5A(i), where a smooth side wall can be observed. After completing the Si rigid mold, sNIL is performed to reproduce an inverse copy of the Si mold. FIG. 5A(ii) is an SEM image of the PUA soft mold, which has the inverse patterns of the Si mold with protruding features. The sidewall of the PUA mold is smooth which comes from the low roughness of the Si mold, and the high-resolution replication of the sNIL process. The UV-cured PUA as the soft mold offers rigidity and strength that ensures high pattern fidelity during imprinting without pattern collapse. The high pattern fidelity is especially important to ensure that the coupling region is accurately replicated. FIG. 5A(iii) shows the PUA mold to PUA imprinting results. Due to the low surface energy property of PUA, it can easily self-replicate with high resolution without distortion. The imprinted PUA lower cladding layer is a smooth trench that is ready to be filled with the core polymers. The low roughness ensures low optical scattering loss and thus a high-quality factor.

The residual layer-free property is another important aspect for obtaining the high Q factor. FIG. 5B(i) shows the SEM cross-sectional view of the microring after high-index polystyrene ((PS) 10 wt. % in toluene) spin coating and 3 minutes of thermal reflow. The image shows that PS fills into the fabricated trench with a high filling ratio and retracts away from the trench edge, leaving no residual layer near the trench. This phenomenon happens across the whole waveguide trench including the microring area. FIG. 5B(ii) shows the top view near the microring area. The edge of the spin-coated high-index polymer film is 2-3 μm away from the bending ring, which ensures the microring core waveguide has low radiation loss. This feature is advantageous to confine the mode within the PS layer inside the trench, preventing radiation loss. To our best understanding, this is believed to be the first time this kind of shape in a microring resonator has been achieved. FIG. 5B(iii) is the magnified image of the boxed area in FIG. 5B(ii). In the coupling region, some high-index polymer is observed. This is because the polymer is surrounded by the trench and has no place to retract. However, it may only affect the coupling ratio slightly. FIG. 5C shows a cross-sectional SEM image of a cladded structure/imprinted waveguide formed according to certain aspects of the present disclosure, having the lower cladding, the core region disposed in the microfeature/trench and an upper cladding disposed over the lower cladding and core region.

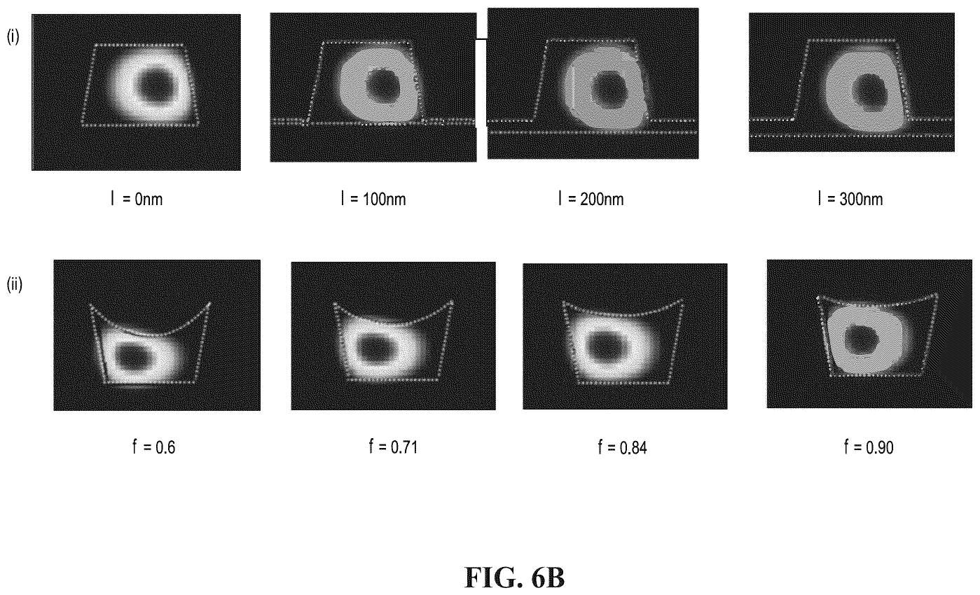

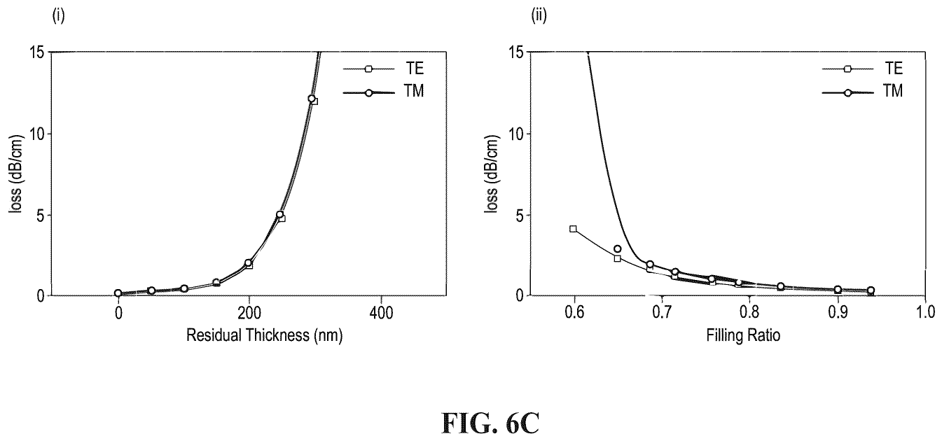

Next, radiation loss and residual layer simulation is investigated. The residual layer-free feature of the microring formed according to various aspects of the present disclosure helps to achieve high quality-factor. FIG. 6A includes FIGS. 6A(i)-6A(ii) that illustrate a cross-section profile and a refractive index distribution of the fabricated waveguides formed by either FIG. 6A(i) a conventional thermal embossing nano-imprint lithography (NIL) method or FIG. 6A(ii) showing a structure formed via the DsNIL method according to certain aspects of the present disclosure. For the conventional thermal embossing, the core of the waveguide is a trapezoid with w1=2.1 μm and w2=1.7 μm, and height (h)=1.4 μm. A thin residual core layer with thickness (l) lies between the under-cladding layer and the trapezoid. Though the waveguide mode primarily resides within the trapezoid-shaped polystyrene with refractive index=1.58 (drawn in red), the residual layer results in wave leakage leading to increased radiation loss in the curved ring region. The lower cladding layer (drawn in blue) is SiO₂ with a refractive index=1.45 and the upper cladding layer is PUA with an index=1.49 (green). For the structure formed by an inventive DsNIL method, the length of the bottom edge of the core (w2) is 1.7 μm, and the distance between the meniscus and the bottom edge is defined as d, which varies with the concentration of the spin-coated polymer. The filling ratio (f) is defined as the ratio depth (d) over height (h) (f=d/h). In this simulation, the core of the waveguide is the enclosed area by the two trapezoidal hypotenuses and meniscus curve and the bottom edge of the trapezoid and is filled with polystyrene with refractive index n=1.58 (drawn in red). The rest area is the cladding layer formed by PUA with n=1.49.

FIG. 6B includes FIGS. 6B(i)-6B(ii) that show the field distribution of the guided TE mode with a 100 μm bending radius with various residual layer thicknesses. Despite only a few hundred nanometers of residual layer in the structures in FIG. 6B(i), the residual layer can significantly cause mode leakage and thus result in significant radiation loss as shown in the black curve of FIG. 6C(i) validating the necessity of the residual layer etching when structures are formed via such methods. FIG. 6B(ii) show the mode profiles of the waveguides fabricated from the inventive DsNIL method with different polymer filling ratios (i.e., f=0.6, 0.71, 0.84, and 0.9). For the low filling ratio of f=0.6, more field is squeezed near the edges, resulting in a lower mode confinement factor and higher radiation loss. As the filling ratio becomes higher, more field is confined inside the core. The black TE curve in FIG. 6C(ii) plots the radiation loss of 100 micrometer radius versus the polymer filling ratio. When the filling ratio (f) is above 0.7, the radiation loss is <1 dB and corresponds to an approximate 280,000 intrinsic Q-factor. The radiation loss of both TE/TM modes based on the thermal embossing method and the inventive method are plotted in FIGS. 6C(i) and 6C(ii), respectively. It is worth noting that for the cladded structures made by the conventional thermal embossing method, the TE and TM modes demonstrate similar trends; however, for the cladded structures made via DsNIL, there is an appreciable difference between the TE and TM modes when at a low filling ratio. This can be attributed to the special shape of the core cross-section, where the two modes have very different mode confinement.

Additional advantages of damascene soft nanoimprinting lithography (DsNIL) are discussed herein. Aside from the high Q-factor due to the low sidewall roughness and the residual layer-free properties, DsNIL also has one or more of the following advantages: (1) minimal fabrication defects; (2) flexibility to use multiple distinct core material polymers; (3) unique and controllable waveguide profiles/shapes; and (4) flexible choices of substrates.

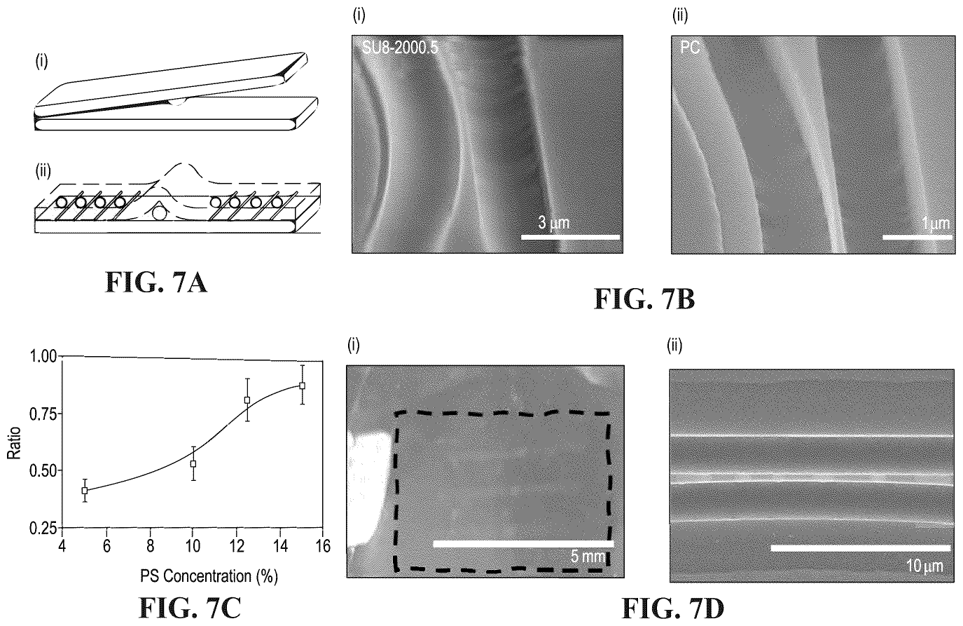

The ability to minimize defects in the inventive DsNIL methods results from the nature of soft imprinting lithography and the imprinting of a thick cladding layer instead of a thin core layer. As illustrated in FIG. 7A(i), conventional hard mold nanoimprinting suffers from dust issues and thus resulting defects. Even though only tiny dust particles are left between the mold and substrate, a large area surrounding the dust cannot be imprinted due to the rigidity of the Si mold. This can result in catastrophic defect and can influence the entire imprinting result and cause a catastrophic defect due to use of a rigid mold and thin polymer layer. In addition, the thin polymer imprinting by hard pressing can easily cause other influences, such as fingering, polymer dewetting, and incomplete waveguide filling. In contrast, the inventive soft imprinting methods provide a greater tolerance to the presence of dust particles, because the soft mold can deform around the particle and hence confines defects in a local region, as FIG. 7A(ii). Moreover, the imprinted under cladding polymer is thick (e.g., about 7 micrometers) and can serve as a cushion buffer layer during imprinting to prevent the dust from damaging the mold, as well as imprinting defects due to non-polymer contact. This low defect property of the inventive methods allows the user to easily implement it with simple tools in the normal laboratory environment, where a clean-room or minimal dust/dust-free environment are not required.

Different polymers can be filled into the patterned (e.g., PUA) cladding trench, so long as they are formulated to be low-viscosity high refractive index materials, such that the spin-coated materials form thin enough polymer films. FIG. 7B(i) shows a profile of SU8-2000.5 polymer, while FIG. 7B(ii) shows 6% of polycarbonate after spin coating at 1000 rpm, followed by 3 minutes of annealing/thermal reflow. All materials can successfully fill into the waveguide trenches and result in no residual layers except the gap areas. For the SU8-2000.5, it is cured by 320-390 nm UV light with 225 mW/cm² for 3 minute. These results establish that the inventive methods can be utilized for both UV-cured polymers, thermoplastic polymers, and as will be appreciated by those of skill in the art, can be extended to other polymers.

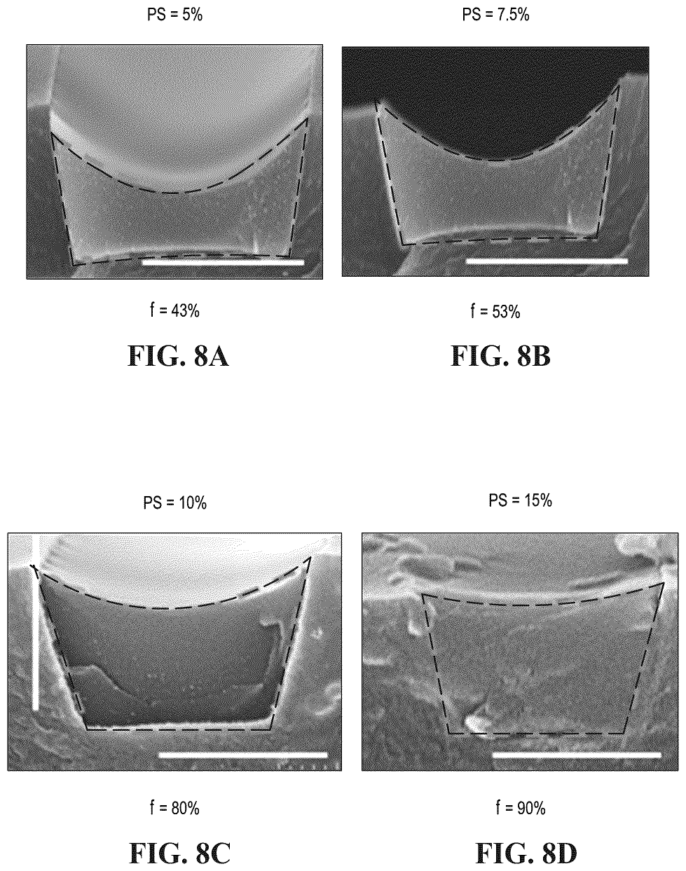

The meniscus profile of the filled trench is unique and tunable by the concentration of the polymer. As illustrated in FIGS. 7C and 8A-8D, the meniscus profile varies with the concentration of the polystyrene ((PS) ranging from about 5% to about 15%). The filling height increases with the polymer concentration. FIG. 7C plots a statistical filling ratio into a 1.4 micrometer (μm) deep, 2.1 μm wide trench versus 4 different PS concentrations of 3 separate measurements. For 5% of polystyrene (FIG. 8A), the filling height is about 43%. As the concentration reaches 15% (FIG. 8D), the filling height is about 1.22 μm, corresponding to an approximate 90% filling ratio. According to the observations, no significant residual layer is observed up to 90% filling ratio. This filling ratio is closely related to the mode of confinement and thus the optical radiation loss of the microring resonator.

The proposed fabrication method can be easily applied on various substrates, including soft PET (Polyethylene terephthalate) substrates, as illustrated in FIG. 7D that includes FIGS. 7D(i) and 7D(ii). In FIG. 7D(i), three sets of microring resonators are imprinted on a transparent PET substrate. This is unachievable with the traditional thermal embossing method due to the requirement of high-temperature pressing that can cause the melting of the polymer substrate and thus severe plastic substrate deformation. As shown in FIG. 7D(ii), the imprinting also shows a high fidelity imprinting on the soft substrate, and no residual property is also observed. As such, these results demonstrate the various advantages of DsNIL methods provided in accordance with certain aspects of the present disclosure, including a cladded optic structure in the form of a microring resonator that have high-quality factor, residual layer free, facile fabrication, unique mode profile, low radiation loss, and can be formed on a flexible substrate.

Additionally, many other potential applications can be explored with such an inventive DsNIL method. First, different properties of materials can be incorporated into a microring resonator, and various functionalities can be performed. The traditional E-beam lithography-based method can be only used for limited materials such as silicon (Si) and silicon nitride (SiN) that are compatible with the CMOS process. The nanoimprinting lithography based method only allows polymers that are imprintable and with sufficient strength to survive the demolding process. In contrast, the inventive methods only requires that the materials to be spin coated and to exhibit reflow under thermal treatment/annealing conditions to form the microring resonators or other cladded optic structures, which can be satisfied by numerous polymers. Therefore, additional materials, such as electro-optical polymers for EO modulation, thermo-optical polymers for thermal tuning, fluorescent materials for polymer lasers, large non-linearity materials for frequency comb generation, high photoelastic materials for ultrasound sensing can all be used. In addition, multiple materials with different properties can also be combined into the same microrings to form multi-functional microring devices.

Second, more functionalities can be also introduced by using different cladding materials. Optical microring resonator properties not only depend on the core materials, but also on the cladding layer material. PUA as the cladding layer provides a unique advantage for sensing. PUA is known to have high photoelastic and thermal-elastic coefficients and can be potentially used for strain and temperature sensing. However, the inventive methods are not limited to PUA, but can be expanded to various other imprintable materials.

Third, the flexible substrate enables more versatile platforms. Conventionally, the microring resonators are fabricated on hard substrates, such as silicon dioxide (SiO₂) on silicon (Si) or glass substrates, because of the use of the traditional microfabrication process. Even though some techniques can be applied to transfer the fabricated microring resonator from silicon (Si) to a plastic substrate, it is usually difficult to achieve and with low yield. The inventive methods, in contrast, can directly fabricate microrings on a flexible substrate, such as PET plastic film without any need for transferring. The flexible substrate enables the possibility of making wearable devices for strain sensing, and health monitoring. It also allows the miniaturization of the system volume, which is crucial in biomedical applications.

Fourth, the inventive DsNIL methods can be expanded to roll-to-roll printing for mass production. Due to the simple procedure, high dust tolerance, compatibility with flexible substrates, and high robustness, it is possible for such methods to be conducted on a roll-to-roll platform for mass production in a regular lab environment. With this method, roll-to-roll processing can be utilized for patterning a cladding layer first. After this is completed, the fabricated sample can be spin-coated on a spin-coater for core material filling.

Fifth, the mode profile is controllable by adjusting the filling ratio of core materials. As shown above, this can be achieved by spin-coating different concentrations of core materials. Another method may comprise multiple spinning cycles. By spinning the core materials multiple times, the filling rate of the core materials can be tuned, and thus the confinement factor of the core region. This strategy allows the user to dynamically tune the mode confinement factor to achieve the best device performance. For example, an athermal microring resonator requires the confinement factor to be precisely controlled to cancel the thermo-optic effects from the core and cladding layer. However, this is hard to control and cannot be dynamically tuned by other methods. With this mode-tuning strategy provided by certain aspects of the present disclosure, this can be easily realized.

Notably, the refractive index of the commonly used cladding materials SiO₂ (n=1.45) and PUA (n=1.49) are relatively large and cause mode leakage in small diameter microring resonators (radius (r)<30 μm). By using low refractive index materials, such as CYTOP (n=1.34), and SiO₂ aerogel (n=1.08), better mode confinement can be achieved and small radius microring resonators are achievable. In certain variations, a polymer-based cladding layer may not always be desirable. For example, the large photo-thermal coefficient of PUA can potentially make the ring resonator sensitive to temperature variation and result in resonant condition changes. To address this, one can use the traditional damascene method to pattern the trench on a desired substrate, such as SiO₂ first. Then, the spin coating of the polymer filling step can be left to the last step. In this way, the process can be more compatible with existing CMOS fabrication and photonic integrated circuits.

High aspect ratio (h/w) structures could be more challenging by using the inventive DsNIL methods, for example, due to difficulty in complete filling of the trenches during spin-coating or leaving a much thicker residual layer atop of the plateau regions. However, in certain alternative aspects, this could be solved by spin-coating high index polymers of appropriate concentrations, followed by plasma etching to remove the excessive residual layer and then apply thermal reflow. This plasma etching may not directly roughen the side wall surface since it is covered by the residual layer.

For polymers for which the concentration cannot be adjusted easily, the filling ratio of the core layer can be tuned by multiple times of spin coating (for low concentration solution) or plasma etching after the filling (for the high concentration case). Liquid polymers with low concentrations (2% of PC solution) and excessively high concentrations (20% of PS solution) can also be used for forming the waveguide by multiple filling and plasma etching respectively. These operations will not introduce roughness to the waveguide while achieving residual layer free property.

The polymer filling and the residual layer free property depend on the polymer interfacial energy and may require surface modification for different materials. This modification can be realized by changing the surface energy of the cladding layer by gentle plasma etching or surface treatments by using surfactants. As described above, no further surface modification is necessary for filling polycarbonate, SU8-2000.5 and polystyrene.

In conclusion, the present disclosure provides high-quality (Q)-factor microring resonators and other cladded optic structures formed by inventive methods of “damascene soft nanoimprinting lithography,” which are highly desirable in many applications. While fabricating a microring resonator typically requires delicate instruments to ensure a smooth side wall of waveguides and 100-nm critical feature size in the coupling region, such instruments and equipment are not required in the methods of the present disclosure. The inventive methods can create a high-fidelity waveguide by simply backfilling an imprinted cladding pattern with a high refractive index polymer core. Such methods can easily realize high Q-factor microring resonators (e.g., approximately 5×10⁵ around 770 nm wavelength) without the use of any expensive instruments and can be conducted in a normal lab environment without the need for a clean room or other dust free environment. The high Q-factors can be attributed to the residual layer-free feature and controllable meniscus cross-section profile of the filled polymer core. Furthermore, such methods are compatible with different polymers, yield low fabrication defects, enable new functionalities, and allows use of flexible substrates. These benefits can broaden the applicability of the fabricated microring resonators.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of making a templated optical structure, the method comprising:
patterning a first surface of a moldable polymer disposed on a first substrate by contacting a rigid inverse mold having at least one trench microfeature with the first surface of the moldable polymer to define at least one inverse trench microfeature in the first surface;
imprinting the first surface of the moldable polymer having the at least one inverse trench microfeature into a second surface of a first polymeric cladding layer disposed on a second substrate to replicate the at least one trench microfeature contrapositive to the at least one inverse trench microfeature in the second surface, wherein the first polymeric cladding layer has a first refractive index;
applying a liquid polymeric precursor into the at least one trench microfeature on the second surface of the first polymeric cladding layer and solidifying the liquid polymeric precursor to form a solid polymer having a second refractive index, wherein a difference between the first refractive index and the second refractive index is greater than or equal to about 0.05; and
heating the solid polymer to facilitate retraction from regions of the second surface external to the at least one trench microfeature and annealing for thermal reflow of the solid polymer in the at least one trench microfeature, wherein the solid polymer disposed in the at least one trench microfeature defines an optic feature embedded in the first polymeric cladding layer.

2. The method of claim 1, further comprising applying a second polymeric cladding layer over the solid polymer in the at least one trench microfeature in the second surface of the first polymeric cladding layer, wherein the solid polymer disposed in the at least one trench microfeature defines the optic feature embedded in the first polymeric cladding layer and the second polymeric cladding layer.

3. The method of claim 2, wherein the moldable polymer comprises polyurethaneacrylate (PUA) and the first polymeric cladding and the second polymeric cladding respectively comprise polyurethaneacrylate (PUA).

4. The method of claim 2, wherein the second polymeric cladding layer is formed from:
(i) a liquid comprising an ultraviolet radiation (UV)-curable polymer precursor and the applying the second polymeric cladding layer over the solid polymer in the at least one trench microfeature in the second surface of the first polymeric cladding layer further comprises applying ultraviolet (UV) radiation to cure the liquid to form a solid second polymeric cladding layer;
(ii) a liquid comprising a thermoset polymer precursor and the applying the second polymeric cladding layer over the solid polymer in the at least one trench microfeature in the second surface of the first polymeric cladding layer further comprises applying heat to cure the liquid to form a solid second polymeric cladding layer;
(iii) a liquid comprising a thermoplastic polymer and the applying the second polymeric cladding layer over the solid polymer in the at least one trench microfeature in the second surface of the first polymeric cladding layer further comprises applying heat or solvent evaporation to form a solid second polymeric cladding layer; or
(iv) a liquid comprising cross-linked molecules that after solidification forms an aerogel material having a porous network of the cross-linked molecules.

5. The method of claim 1, wherein the liquid polymeric precursor comprises of one or more polymer precursors dissolved in a solution.

6. The method of claim 1, wherein the applying the liquid polymeric precursor into the at least one trench comprises:
(i) spin casting the liquid polymeric precursor into the at least one trench on the surface of the first polymeric cladding layer; or
(ii) printing the liquid polymeric precursor in a printing process selected from the group consisting of: ink-jet printing, aerosol jet printing, electrohydrodynamic printing, photoacoustic printing, and combinations thereof.

7. The method of claim 6, wherein the applying comprises (i) the spin casting that further comprises at least two spin casting steps of the liquid polymeric precursor to form at least two layers in the at least one trench on the surface of the first polymeric cladding layer.

8. The method of claim 1, wherein the regions of the second surface external to the at least one trench microfeature are substantially free of any solid polymer.

9. The method of claim 1, wherein the moldable polymer is:
(i) a liquid comprising an ultraviolet radiation (UV)-curable polymer precursor and the patterning of the first surface of the moldable polymer further comprises applying ultraviolet (UV) radiation to cure the liquid to form a solid moldable polymer during the contacting with the rigid inverse mold;
(ii) a liquid comprising a thermosetting polymer precursor and the patterning of the first surface of the moldable polymer further comprises applying thermal energy to cure the liquid to form a solid moldable polymer during the contacting with the rigid inverse mold; or
(iii) a thermoplastic polymer and the patterning of the first surface of the moldable polymer further comprises applying heat and pressure to form a solid moldable polymer during the contacting with the rigid inverse mold.

10. The method of claim 1, wherein the first polymeric cladding layer is formed from:
(i) a liquid comprising an ultraviolet radiation (UV)-curable polymer precursor and the imprinting further comprises applying ultraviolet (UV) radiation to cure the liquid to a solid to form the first polymeric cladding layer having the at least one trench microfeature in the second surface;
(ii) a liquid comprising a thermoset polymer precursor and the imprinting further comprises applying pressure and heat to cure the liquid to form the solid first polymeric cladding layer having the at least one trench microfeature in the second surface; or
(iii) a liquid comprising a thermoplastic polymer and the imprinting further comprises applying pressure and heat to form the solid first polymeric cladding layer having the at least one trench microfeature in the second surface.

11. The method of claim 1, wherein the solid polymer is selected from the group consisting of: polystyrene (PS), polycarbonate (PC), polymethylmethacrylate (PMMA), epoxy-based resin, silsesquioxane resin, electrooptic polymers, thermooptic polymers, photothermal polymers, photoelastic polymers, a polymer comprising dyes or quantum dots, a composite comprising a plurality of nanoparticles distributed in a polymer, and combinations thereof.

12. The method of claim 1, wherein the solid polymer comprises polystyrene (PS).

13. The method of claim 1, where the second substrate comprises a flexible polymer.

14. The method of claim 1, wherein after the heating, the second surface of the first polymeric cladding layer is free of any residual solid polymer having the second refractive index without any removal processes.

15. The method of claim 1, further comprising removing the first polymeric cladding layer after heating the solid polymer.

16. A method of making an organic microring resonator optic structure, the method comprising:
patterning a first surface of a moldable polymer disposed on a first substrate by contacting a rigid inverse mold having at least one trench microfeature with the first surface of the moldable polymer to define at least one inverse trench microfeature in the first surface;
imprinting the first surface of the moldable polymer having the at least one inverse trench microfeature into a second surface of a first polymeric cladding layer disposed on a second substrate to replicate the at least one trench microfeature contrapositive to the at least one inverse trench microfeature in the second surface, wherein the first polymeric cladding layer has a first refractive index;
applying a liquid polymeric precursor into the at least one trench microfeature on the second surface of the first polymeric cladding layer;
and solidifying the liquid polymeric precursor to form a solid polymer having a second refractive index, wherein a difference between the first refractive index and the second refractive index is greater than or equal to about 0.05;
heating the solid polymer to facilitate retraction from regions of the second surface external to the at least one trench microfeature and annealing for thermal reflow of the solid polymer in the at least one trench microfeature; and
applying a second polymeric cladding layer over the solid polymer in the at least one trench microfeature in the second surface of the first polymeric cladding layer, wherein the solid polymer disposed in the at least one trench microfeature defines a waveguide of the organic microring resonator optic structure embedded in the first polymeric cladding layer and the second polymeric cladding layer, wherein the organic microring resonator optic structure has a quality (Q)-Factor of greater than or equal to about 1×10⁵ at a wavelength of about 770 nm.

17. The method of claim 16, wherein the regions of the second surface external to the at least one trench microfeature are substantially free of any solid polymer.

18. The method of claim 16, wherein the moldable polymer comprises polyurethaneacrylate (PUA) and the first polymeric cladding and the second polymeric cladding respectively comprise polyurethaneacrylate (PUA).

19. The method of claim 16, wherein the solid polymer is selected from the group consisting of: polystyrene (PS), polycarbonate (PC), epoxy-based resin, polymethylmethacrylate (PMMA), silsesquioxane resin, electrooptic polymers, thermooptic polymers, photothermal polymers, photoelastic polymers, a polymer comprising a dye or a quantum dot, a composite comprising a nanoparticle distributed in a polymer, and combinations thereof.

20. The method of claim 16, where the second substrate comprises a flexible polymer.

21. The method of claim 16, wherein the first polymeric cladding and the second polymeric cladding respectively comprise polyurethaneacrylate (PUA) and the solid polymer comprises polystyrene (PS).

22. The method of claim 16, wherein after the heating and the solidifying, the regions of the second surface of the first cladding layer external to the at least one trench microfeature are free of any residual solid polymer having the second refractive index without any removal processes.

23. A polymeric microring resonator optic structure comprising:
a first polymeric cladding layer disposed on a substrate having at least one trench microfeature, wherein the first polymeric cladding layer has a first refractive index and the first polymeric cladding layer defines surface regions external to the at least one trench microfeature;
a solid polymer having a second refractive index disposed in the at least one trench microfeature and defining a meniscus, wherein a difference between the first refractive index and the second refractive index is greater than or equal to about 0.05, wherein the regions external to the at least one trench microfeature of the first polymeric cladding layer are substantially free of the solid polymer; and
a second polymeric cladding layer disposed over the surface regions and the solid polymer in the at least one trench microfeature, wherein the solid polymer disposed in the at least one trench microfeature defines a waveguide of the polymeric microring resonator optic structure embedded in the first polymeric cladding layer and the second polymeric cladding layer, wherein the polymeric microring resonator optic structure has a quality (Q)-Factor of greater than or equal to about 1×10⁵ at a wavelength of about 770 nm quality.

24. The polymeric microring resonator optic structure of claim 23, wherein the solid polymer is selected from the group consisting of: polystyrene (PS), polycarbonate (PC), epoxy-based resin, polymethylmethacrylate (PMMA), silsesquioxane resin, electrooptic polymers, thermooptic polymers, photothermal polymers, photoelastic polymers, a polymer comprising a dye or a quantum dot, a composite comprising a nanoparticle distributed in a polymer, and combinations thereof.

25. The polymeric microring resonator optic structure of claim 23, wherein the substrate comprises a flexible polymer.

26. The polymeric microring resonator optic structure of claim 23, wherein the first polymeric cladding and the second polymeric cladding respectively comprise polyurethaneacrylate (PUA) and the solid polymer comprises polystyrene (PS).

27. The polymeric microring resonator optic structure of claim 23, wherein the surface regions external to the at least one trench microfeature of the first cladding layer are free of any residual solid polymer having the second refractive index.

28. The polymeric microring resonator optic structure of claim 23, wherein the solid polymer is a composite comprising a plurality of nanoparticles distributed in a polymer matrix.
